(19) United States
(12) Patent Application Publication
(10) Pub. No.: US 2026/0214213 A1
(43) Pub. Date: Jul. 23, 2026

(54) Method and Apparatus of Intra Prediction Generation in Video Coding System

(71) Applicant: MEDIATEK INC., Hsinchu City (TW)

(72) Inventors: Man-Shu CHIANG, Hsinchu City (TW); Chih-Wei HSU, Hsinchu City (TW)

(21) Appl. No.: 19/141,179

(22) PCT Filed: Dec. 19, 2023
(86) PCT No.: PCT/CN2023/139977

§ 371 Date: Jun. 19, 2025

Related U.S. Application Data
(60) Provisional application No. 63/476,169, filed on Dec. 20, 2022.

(51) Int. Cl. H04N 19/11; H04N 19/119; H04N 19/176; H04N 19/46

(52) U.S. Cl. CPC H04N 19/11; H04N 19/119; H04N 19/176; H04N 19/46

(57) ABSTRACT

A method and apparatus for region-based prediction mode derivation. According to this method, a predefined target mode uses template-based histogram, gradient analysis, or template-based distortion calculation. A first flag for the current block is signalled or parsed to indicate whether to apply a region-based mode derivation process to the current block. If the first flag indicating the region-based mode derivation process being applied: the template is divide into at least two template regions; at least two intra prediction modes are derived from the at least two template regions using a predefined measurement for the at least two template regions respectively, where the predefined measurement includes deriving at least one candidate list including at least one of the at least two intra prediction modes; and at least two hypotheses of predictors are derived based on the at least two intra prediction modes to derive final predictor.

### CROSS REFERENCE TO RELATED APPLICATIONS

The present invention is a non-Provisional Application of and claims priority to U.S. Provisional Patent Application No. 63/476,169, filed on Dec. 20, 2022. The U.S. Provisional Patent Application is hereby incorporated by reference in its entirety.

### FIELD OF THE INVENTION

The present invention relates to video coding system. In particular, the present invention relates to schemes to improve performance of intra prediction coding using a new scheme to generate intra prediction mode.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Partitioning of the CTUs Using a Tree Structure

In HEVC, a CTU is split into CUs by using a quaternary-tree (QT) structure denoted as coding tree to adapt to various local characteristics. The decision whether to code a picture area using inter-picture (temporal) or intra-picture (spatial) prediction is made at the leaf CU level. Each leaf CU can be further split into one, two or four Pus according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 2, there are four splitting types in multi-type tree structure, vertical binary splitting (SPLIT_BT_VER 210), horizontal binary splitting (SPLIT_BT_HOR 220), vertical ternary splitting (SPLIT_TT_VER 230), and horizontal ternary splitting (SPLIT_TT_HOR 240). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 3 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In quadtree with nested multi-type tree coding tree structure, for each CU node, a first flag (split_cu_flag) is signalled to indicate whether the node is further partitioned. If the current CU node is a quadtree CU node, a second flag (split_qt_flag) whether it's a QT partitioning or MTT partitioning mode. When a node is partitioned with MTT partitioning mode, a third flag (mtt_split_cu_vertical_flag) is signalled to indicate the splitting direction, and then a fourth flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1.

TABLE 1
MttSplitMode derivation based on multi-type tree syntax elements

| MttSplitMode | mtt_split_cu_vertical_flag | mtt_split_cu_binary_flag |
|---|---|---|
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

FIG. 4 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined for the quadtree with nested multi-type tree coding tree scheme. These parameters are specified by SPS syntax elements and can be further refined by picture header syntax elements.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinCbSize: the minimum allowed coding block node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinCbsize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 128×128). Otherwise, the leaf qdtree node could be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinCbsize, no further horizontal splitting is considered. Similarly, when the multi-type tree node has height equal to MinCbsize, no further vertical splitting is considered.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

### Virtual Pipeline Data Units (VPDUs)

Virtual pipeline data units (VPDUs) are defined as non-overlapping units in a picture. In hardware decoders, successive VPDUs are processed by multiple pipeline stages at the same time. The VPDU size is roughly proportional to the buffer size in most pipeline stages, so it is important to keep the VPDU size small. In most hardware decoders, the VPDU size can be set to maximum transform block (TB) size. However, in VVC, ternary tree (TT) and binary tree (BT) partition may lead to the increasing of VPDUs size.

In order to keep the VPDU size as 64×64 luma samples, the following normative partition restrictions (with syntax signalling modification) are applied in VTM, as shown in FIG. 5:
TT split is not allowed (as indicated by “X” in FIG. 5) for a CU with either width or height, or both width and height equal to 128.
For a 128×N CU with N≤64 (i.e. width equal to 128 and height smaller than 128), horizontal BT is not allowed.
For an N×128 CU with N≤64 (i.e. height equal to 128 and width smaller than 128), vertical
BT is not allowed.

In FIG. 5, the luma block size is 128×128. The dashed lines indicate block size 64×64. According to the constraints mentioned above, examples of the partitions not allowed are indicated by “X” as shown in various examples (510-580) in FIG. 5.

Intra Mode Coding with 67 Intra Prediction Modes

To capture the arbitrary edge directions presented in natural video, the number of directional intra modes in VVC is extended from 33, as used in HEVC, to 65. The new directional modes not in HEVC are depicted as dotted arrows in FIG. 6, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

To keep the complexity of the most probable mode (MPM) list generation low, an intra mode coding method with 6 MPMs is used by considering two available neighbouring intra modes. The following three aspects are considered to construct the MPM list:
Default intra modes
Neighbouring intra modes
Derived intra modes.

A unified 6-MPM list is used for intra blocks irrespective of whether MRL and ISP coding tools are applied or not. The MPM list is constructed based on intra modes of the left and above neighbouring block. Suppose the mode of the left is denoted as Left and the mode of the above block is denoted as Above, the unified MPM list is constructed as follows:
When a neighbouring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
Set a mode Max as the larger mode in Left and Above
   MPM list→{Planar, Max, Max−1, Max+1, Max−2, M+2}
If Left and Above are both angular and they are different:
   Set a mode Max as the larger mode in Left and Above
If Max−Min is equal to 1:
   MPM list→ {Planar, Left, Above, Min−1, Max+1, Min−2}
Otherwise, if Max−Min is greater than or equal to 62:
   MPM list→ {Planar, Left, Above, Min+1, Max−1, Min+2}
Otherwise, if Max−Min is equal to 2:
   MPM list→{Planar, Left, Above, Min+1, Min−1, Max+1}
Otherwise:
   MPM list→{Planar, Left, Above, Min−1, −Min+1, Max−1}
If Left and Above are both angular and they are the same:
MPM list→{Planar, Left, Left−1, Left+1, Left−2, Left+2}

Besides, the first bin of the MPM index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

Secondary MPM lists is introduced as described in JVET-D0114 (Seregin, et al., “Block shape dependent intra mode coding”, Joint Video Exploration Team (JVET) of ITU-T SG 16 WP 3 and ISO/IEC JTC 1/SC 29/WG 11, 4th Meeting: Chengdu, CN, 15-21 Oct. 2016, Document JVET-D0114). The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in the following, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL. FIG. 7 illustrates the locations of the neighbouring blocks (L, A, BL, AR, AL) used in the derivation of a general MPM list for a current block 710.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### Wide-Angle Intra Prediction for Non-Square Blocks

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

To support these prediction directions, the top reference with length 2W+1, and the left reference with length 2H+1, are defined as shown in FIG. 8A and FIG. 8B respectively.

The number of replaced modes in wide-angular direction mode depends on the aspect ratio of a block. The replaced intra prediction modes are illustrated in Table 2.

TABLE 2
Intra prediction modes replaced by wide-angular modes

| Aspect ratio | Replaced intra prediction modes |
|---|---|
| W/H == 16 | Modes 12, 13, 14, 15 |
| W/H == 8 | Modes 12, 13 |
| W/H == 4 | Modes 2, 3, 4, 5, 6, 7, 8, 9, 10, 11 |
| W/H == 2 | Modes 2, 3, 4, 5, 6, 7, |
| W/H == 1 | None |
| W/H == 1/2 | Modes 61, 62, 63, 64, 65, 66 |
| W/H == 1/4 | Mode 57, 58, 59, 60, 61, 62, 63, 64, 65, 66 |
| W/H == 1/8 | Modes 55, 56 |
| W/H == 1/16 | Modes 53, 54, 55, 56 |

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135° and above 45°, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### Decoder Side Intra Mode Derivation (DIMD)

When DIMD is applied, two intra modes are derived from the reconstructed neighbour samples, and those two predictors are combined with the planar mode predictor with the weights derived from the gradients. The DIMD mode is used as an alternative prediction mode and is always checked in the high-complexity RDO mode.

To implicitly derive the intra prediction modes of a blocks, a texture gradient analysis is performed at both the encoder and decoder sides. This process starts with an empty Histogram of Gradient (HoG) with 65 entries, corresponding to the 65 angular modes. Amplitudes of these entries are determined during the texture gradient analysis.

In the first step, DIMD picks a template of T=3 columns and lines from respectively left side and above side of the current block. This area is used as the reference for the gradient based intra prediction modes derivation.

In the second step, the horizontal and vertical Sobel filters are applied on all 3×3 window positions, centred on the pixels of the middle line of the template. At each window position, Sobel filters calculate the intensity of pure horizontal and vertical directions as Gx and G_{y}, respectively. Then, the texture angle of the window is calculated as:

$$angle = arc tan ( {G}_{x} / {G}_{y} ) , \qquad ( 1 )$$

which can be converted into one of 65 angular intra prediction modes. Once the intra prediction mode index of current window is derived as idx, the amplitude of its entry in the HoG[idx] is updated by addition of:

$$ampl = \vert {G}_{x} \vert + \vert {G}_{y} \vert \qquad ( 2 )$$

FIGS. 9A-C show an example of HoG, calculated after applying the above operations on all pixel positions in the template. FIG. 9A illustrates an example of selected template 920 for a current block 910. Template 920 comprises T lines above the current block and T columns to the left of the current block. For intra prediction of the current block, the area 930 at the above and left of the current block corresponds to a reconstructed area and the area 940 below and at the right of the block corresponds to an unavailable area. FIG. 9B illustrates an example for T=3 and the HoGs are calculated for pixels 960 in the middle line and pixels 962 in the middle column. For example, for pixel 952, a 3×3 window 950 is used. FIG. 9C illustrates an example of the amplitudes (ampl) calculated based on equation (2) for the angular intra prediction modes as determined from equation (1).

Once HoG is computed, the indices with two tallest histogram bars are selected as the two implicitly derived intra prediction modes for the block and are further combined with the Planar mode as the prediction of DIMD mode. The prediction fusion is applied as a weighted average of the above three predictors. To this aim, the weight of planar is fixed to 21/64 (~⅓). The remaining weight of 43/64 (~⅔) is then shared between the two HoG IPMs, proportionally to the amplitude of their HoG bars. FIG. 10 illustrates an example of the blending process. As shown in FIG. 10, two intra modes (M1 1012 and M2 1014) are selected according to the indices with two tallest bars of histogram bars 1010. The three predictors (1040, 1042 and 1044) are used to form the blended prediction. The three predictors correspond to applying the M1, M2 and planar intra modes (1020, 1022 and 1024 respectively) to the reference pixels 1030 to form the respective predictors. The three predictors are weighted by respective weighting factors (@1, @2 and @3) 1050. The weighted predictors are summed using adder 1052 to generated the blended predictor 1060. Note that, if only one mode (i.e., single mode) exists in the histogram, then no blending process, and no second DIMD mode.

Besides, the two implicitly derived intra modes are included into the MPM list so that the DIMD process is performed before the MPM list is constructed. The primary derived intra mode of a DIMD block is stored with a block and is used for MPM list construction of the neighbouring blocks.

### Template-Based Intra Mode Derivation (TIMD)

Template-based intra mode derivation (TIMD) mode implicitly derives the intra prediction mode of a CU using a neighbouring template at both the encoder and decoder, instead of signalling the intra prediction mode to the decoder. As shown in FIG. 11, the prediction samples of the template (1112 and 1114) for the current block 1110 are generated using the reference samples (1120 and 1122) of the template for each candidate mode. A cost is calculated as the SATD (Sum of Absolute Transformed Differences) between the prediction samples and the reconstruction samples of the template. The intra prediction mode with the minimum cost is selected as the DIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

For each intra prediction mode in MPMs, the SATD between the prediction and reconstruction samples of the template is calculated. First two intra prediction modes with the minimum SATD are selected as the TIMD modes. These two TIMD modes are fused with weights after applying PDPC process, and such weighted intra prediction is used to code the current CU. Position dependent intra prediction combination (PDPC) is included in the derivation of the TIMD modes.

The costs of the two selected modes are compared with a threshold, in the test, the cost factor of 2 is applied as follows:

$$costMode 2 < 2 * costMode 1.$$

If this condition is true, the fusion is applied, otherwise only model is used (i.e., single mode case). Weights of the modes are computed from their SATD costs as follows:

$$weight 1 = costMode 2 / ( costMode 1 + costMode 2 )$$

$$weight 2 = 1 - weight 1.$$

### Intra Sub-Partitions (ISP)

The intra sub-partitions (ISP) divides luma intra-predicted blocks vertically or horizontally into 2 or 4 sub-partitions depending on the block size. For example, the minimum block size for ISP is 4×8 (or 8×4). If block size is greater than 4×8 (or 8×4), then the corresponding block is divided by 4 sub-partitions. It has been noted that the M×128 (with M≤64) and 128×N (with N≤64) ISP blocks could generate a potential issue with the 64× 64 VDPU (Virtual Decoder Pipeline Unit). For example, an M×128 CU in the single tree case has an M×128 luma TB and two corresponding M/2×64 chroma TBs. If the CU uses ISP, then the luma TB will be divided into four M×32 TBs (only the horizontal split is possible), each of them smaller than a 64× 64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64× 64 decoder pipeline. For this reason, the CU size that can use ISP is restricted to a maximum of 64× 64. FIG. 12A and FIG. 12B shows examples of the two possibilities. All sub-partitions fulfil the condition of having at least 16 samples.

In ISP, the dependence of 1×N and 2×N subblock prediction on the reconstructed values of previously decoded 1×N and 2×N subblocks of the coding block is not allowed so that the minimum width of prediction for subblocks becomes four samples. For example, an 8×N (N>4) coding block that is coded using ISP with vertical split is partitioned into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks compared to processing 4×4 regular-coded intra blocks.

TABLE 3

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed consecutively. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 3. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
Transform size restriction: all ISP transforms with a length larger than 16 points uses the DCT-II.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let t_{H} and t_{V} be the horizontal and the vertical transforms selected respectively for the w×h sub-partition, where w is the width and h is the height. Then the transform is selected according to the following rules:
   If w=1 or h=1, then there is no horizontal or vertical transform respectively.
   If w≥4 and w≤16, t_{H}=DST-VII, otherwise, t_{H}=DCT-II
   If h≥4 and h≤16, t_{V}=DST-VII, otherwise, t_{V}=DCT-II

In ISP mode, all 67 intra modes are allowed. PDPC is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

### Geometric Partitioning Mode (GPM)

In VVC, a Geometric Partitioning Mode (GPM) is supported for inter prediction as described in JVET-W2002 (Adrian Browne, et al., Algorithm description for Versatile Video Coding and Test Model 14 (VTM 14), ITU-T/ISO/IEC Joint Video Exploration Team (JVET), 23rd Meeting, by teleconference, 7-16 Jul. 2021, document: document JVET-W2002). The geometric partitioning mode is signalled using a CU-level flag as one kind of merge mode, with other merge modes including the regular merge mode, the MMVD mode, the CIIP mode and the subblock merge mode. A total of 64 partitions are supported by geometric partitioning mode for each possible CU size, w×h=2^{m}×2ⁿ with m, n∈{3 . . . 6} excluding 8×64 and 64×8. The GPM mode can be applied to skip or merge CUs having a size within the above limit and having at least two regular merge modes.

When this mode is used, a CU is split into two parts by a geometrically located straight line in certain angles. In VVC, there are a total of 20 angles and 4 offset distances used for GPM, which has been reduced from 24 angles in an earlier draft. The location of the splitting line is mathematically derived from the angle and offset parameters of a specific partition. In VVC, there are a total of 64 partitions as shown in FIG. 13, where the partitions are grouped according to their angles and dashed lines indicate redundant partitions. Each part of a geometric partition in the CU is inter-predicted using its own motion; only uni-prediction is allowed for each partition, that is, each part has one motion vector and one reference index. In FIG. 13, each line corresponds to the boundary of one partition. The partitions are grouped according to its angle. For example, partition group 1310 consists of three vertical GPM partitions (i.e., 90°). Partition group 1320 consists of four slant GPM partitions with a small angle from the vertical direction. Also, partition group 1330 consists of three vertical GPM partitions (i.e., 270°) similar to those of group 1310, but with an opposite direction. The uni-prediction motion constraint is applied to ensure that only two motion compensated prediction are needed for each CU, same as the conventional bi-prediction. The uni-prediction motion for each partition is derived using the process described later.

If geometric partitioning mode is used for the current CU, then a geometric partition index indicating the selected partition mode of the geometric partition (angle and offset), and two merge indices (one for each partition) are further signalled. The number of maximum GPM candidate size is signalled explicitly in SPS (Sequence Parameter Set) and specifies syntax binarization for GPM merge indices. After predicting each of part of the geometric partition, the sample values along the geometric partition edge are adjusted using a blending processing with adaptive weights using the process described later. This is the prediction signal for the whole CU, and transform and quantization process will be applied to the whole CU as in other prediction modes. Finally, the motion field of a CU predicted using the geometric partition modes is stored using the process described later.

### Uni-Prediction Candidate List Construction

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate (X=0 or 1, i.e., LX=L0 or L1), with X equal to the parity of n, is used as the n-th uni-prediction motion vector for geometric partitioning mode. These motion vectors are marked with “x” in FIG. 14. In case a corresponding LX motion vector of the n—the extended merge candidate does not exist, the L(1−X) motion vector of the same candidate is used instead as the uni-prediction motion vector for geometric partitioning mode.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 3 )$$

$${ρ}_{j} = {ρ}_{x , j} cos ( {φ}_{i} ) + {ρ}_{y , j} sin ( {φ}_{i} ) \qquad ( 4 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 5 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 6 )$$

where i, j are the indices for angle and offset of a geometric partition, which depend on the signalled geometric partition index. The sign of ρ_{x,j} and ρ_{y,j} depend on angle index i.

The weights for each part of a geometric partition are derived as following:

$$wIdxL ( x , y ) = partIdx ? 32 + d ( x , y ) : 32 - d ( x , y ) \qquad ( 7 )$$

$${w}_{0} ( x , y ) = \frac{Clip 3 ( 0 , 8 , ( wIdxL ( x , y ) + 4 ) ≫ 3 )}{8} \qquad ( 8 )$$

$${w}_{1} ( x , y ) = 1 - {w}_{0} ( x , y ) \qquad ( 9 )$$

The partIdx depends on the angle index i. One example of weigh w₀ is illustrated in FIG. 15, where the angle φᵢ 1510 and offset ρᵢ 1520 are indicated for GPM index i and point 1530 corresponds to the centre of the block. Line 1540 corresponds to the GPM partitioning boundary

### Motion Field Storage for Geometric Partitioning Mode

Mv1 from the first part of the geometric partition, Mv2 from the second part of the geometric partition and a combined MV of Mv1 and Mv2 are stored in the motion filed of a geometric partitioning mode coded CU.

The stored motion vector type for each individual position in the motion filed are determined as:

$$sType = abs ( motioIdx ) < 32 ? 2 : ( motioIdx \leq 0 ? ( 1 - partIdx ) : partIdx ) \qquad ( 10 )$$

where motionIdx is equal to d(4x+2, 4y+2), which is recalculated from equation (3). The partIdx depends on the angle index i.

If sType is equal to 0 or 1, Mv0 or Mv1 are stored in the corresponding motion field, otherwise if sType is equal to 2, a combined MV from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.
   Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals:

$${P}_{bi - pred} = ( ( 8 - w ) * {P}_{0} + w * {P}_{1} + 4 ) ≫ 3$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3, 4, 5}) are used.
At the encoder, fast search algorithms are applied to find the weight index without significantly increasing the encoder complexity. These algorithms are summarized as follows. The details can be found in the VTM software and document JVET-L0646.
When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g. equal weight.

### Combined Inter and Intra Prediction (CIIP)

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pinter is derived using the same inter prediction process applied to regular merge mode; and the intra prediction signal Pintra is derived following the regular intra prediction process with the planar mode. Then, the intra and inter prediction signals are combined using weighted averaging, where the weight value wt is calculated depending on the coding modes of the top and left neighbouring blocks (as shown in FIG. 16) of current CU 1610 as follows:
If the top neighbour is available and intra coded, then set isIntraTop to 1, otherwise set isIntra Top to 0;
If the left neighbour is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + wt * {P}_{intra} + 2 ) >> 2 \qquad ( 11 )$$

### Matrix Weighted Intra Prediction

Matrix weighted intra prediction (MIP) method is a newly added intra prediction technique in VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, i.e., averaging, matrix vector multiplication and linear interpolation as shown in FIG. 17. One line of H reconstructed neighbouring boundary samples 1712 left of the block and one line of W reconstructed neighbouring boundary samples 1710 above the block are shown as dot-filled small squares. After the averaging process, the boundary samples are down-sampled to top boundary line 1714 and left boundary line 1716. The down-sampled samples are provided to the matric-vector multiplication unit 1720 to generate the down-sampled prediction block 1730. An interpolation process is then applied to generate the prediction block 1740.

### Averaging Neighbouring Samples

Among the boundary samples, four samples or eight samples are selected by averaging based on the block size and shape. Specifically, the input boundaries bdry^{top} and bdry^{left} are reduced to smaller boundaries

$${bdry}_{red}^{top} and {bdry}_{red}^{left}$$

by averaging neighbouring boundary samples according to a predefined rule depending on block size. Then, the two reduced boundaries

$${bdry}_{red}^{top} and {bdry}_{red}^{left}$$

are concatenated to a reduced boundary vector bdry_{red} which is thus of size four for blocks of shape 4×4 and of size eight for blocks of all other shapes. If mode refers to the MIP-mode, this concatenation is defined as follows:

$${bdry}_{red} = \{ \begin{matrix}[ {bdry}_{red}^{top} and {bdry}_{red}^{left} ] & for W = H = 4 and mode < 18 \\ [ {bdry}_{red}^{left} and {bdry}_{red}^{top} ] & for W = H = 4 and mode \geq 18 \\ [ {bdry}_{red}^{top} and {bdry}_{red}^{left} ] & for max ( W , H ) = 8 and mode < 10 \\ [ {bdry}_{red}^{left} and {bdry}_{red}^{top} ] & for max ( W , H ) = 8 and mode \geq 10 \\ [ {bdry}_{red}^{top} and {bdry}_{red}^{left} ] & for max ( W , H ) > 8 and mode < 6 \\ [ {bdry}_{red}^{left} and {bdry}_{red}^{top} ] & for max ( W , H ) > 8 and mode \geq 6\end{matrix} .$$

### Matrix Multiplication

A matrix vector multiplication, followed by addition of an offset, is carried out with the averaged samples as an input. The result is a reduced prediction signal on a subsampled set of samples in the original block. Out of the reduced input vector bdry_{red}, a reduced prediction signal pred_{red}, which is a signal on the down-sampled block of width W_{red} and height H_{red} is generated. Here, W_{red} and H_{red} are defined as:

$${W}_{r e d} = \{ \begin{matrix}4 & for max ( W , H ) \leq 8 \\ min ( W , 8 ) & for max ( W , H ) > 8\end{matrix}$$

$${H}_{r e d} = \{ \begin{matrix}4 & for max ( W , H ) \leq 8 \\ min ( H , 8 ) & for max ( W , H ) > 8\end{matrix}$$

The reduced prediction signal pred_{red} is computed by calculating a matrix vector product and adding an offset:

$${pred}_{red} = A \cdot {bdry}_{red} + b .$$

Here, A is a matrix that has W_{red}·H_{red} rows and 4 columns for W=H=4 and 8 columns for all other cases. b is a vector of size W_{red}. H_{red}. The matrix A and the offset vector b are taken from one of the sets S₀, S₁, S₂. One defines an index idx=idx(W, H) as follows:

$$i d x ( W , H ) = \{ \begin{matrix}0 & for W = H = 4 \\ 1 & for max ( W , H ) = 8 \\ 2 & for max ( W , H ) > 8\end{matrix} .$$

Here, each coefficient of the matrix A is represented with 8-bit precision. The set S₀ consists of 16 matrices

$${A}_{0}^{i} , i ∈ \{ 0 , … , 15 \} ,$$

each of which has 16 rows and 4 columns, and 16 offset vectors

$${b}_{0}^{i} , i ∈ \{ 0 , … , 16 \} ,$$

each of size 16. Matrices and offset vectors of that set are used for blocks of size 4×4. The set S₁ consists of 8 matrices

$${A}_{1}^{i} , i ∈ \{ 0 , … , 7 \} ,$$

each of which has 16 rows and 8 columns, and 8 offset vectors

$${b}_{1}^{i} , i ∈ \{ 0 , … , 7 \} ,$$

each of size 16. The set S₂ consists of 6 matrices

$${A}_{2}^{i} , i ∈ \{ 0 , … , 5 \} ,$$

each of which has 64 rows and 8 columns, and 6 offset vectors

$${b}_{2}^{i} , i ∈ \{ 0 , … , 5 \} ,$$

each of size 64.

### Interpolation

The prediction signal at the remaining positions is generated from the prediction signal on the subsampled set by linear interpolation, which is a single-step linear interpolation in each direction. The interpolation is performed firstly in the horizontal direction and then in the vertical direction, regardless of block shape or block size.

Signalling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeld), which determines which matrix is to be used for the given MIP mode is derived as follows

$$isTransposed = predModeIntra \& 1$$

$$modeId = predModeIntra >> 1$$

MIP coding mode is harmonized with other coding tools by considering following aspects:
LFNST (Low-Frequency Non-Separable Transform) is enabled for MIP on large blocks. Here, the LFNST transforms of planar mode are used
The reference sample derivation for MIP is performed exactly as for the conventional intra prediction modes
For the up-sampling step used in the MIP-prediction, original reference samples are used instead of down-sampled ones
Clipping is performed before up-sampling and not after up-sampling
MIP is allowed up to 64×64 regardless of the maximum transform size
The number of MIP modes is 32 for sizeId=0, 16 for sizeId=1 and 12 for sizeId=2

### GPM Extension

Several variations of GPM mode (JVET-W0097 (Zhipin Deng, et. al., “AEE2-related: Combination of EE2-3.3, EE2-3.4 and EE2-3.5”, Joint Video Experts Team (JVET) of ITU-T SG 16 WP 3 and ISO/IEC JTC 1/SC 29, 23rd Meeting, by teleconference, 7-16 Jul. 2021, Document: JVET-W0097) and JVET-Y0065 (Yoshitaka Kidani, et. al., “EE2-3.1: GPM with inter and intra prediction (JVET-X0166)”, Joint Video Experts Team (JVET) of ITU-T SG 16 WP 3 and ISO/IEC JTC 1/SC 29, 25th Meeting, by teleconference, 12-21 Jan. 2022, Document: JVET-Y0065) have been proposed to improve the coding efficiency of the GPM mode in the VVC. The methods were included in the exploration experiment (EE2) for further evaluations, the main technical aspects of which are described as follows:

EE2-3.3 on GPM with MMVD (GPM-MMVD): 1) additional MVDs are added to the existing GPM merge candidates; 2) the MVDs are signalled in the same manner as the MMVD in the VVC, i.e., one distance index plus one direction index; 3) two flags are signalled to separately control whether the MMVD is applied to each GPM partition or not.

EE2-3.4-3.5 on GPM with template matching (GPM-TM): 1) template matching is extended to the GPM mode by refining the GPM MVs based on the left and above neighbouring samples of the current CU; 2) the template samples are selected dependent on the GPM split direction; 3) one single flag is signalled to jointly control whether the template matching is applied to the MVs of two GPM partitions or not.

JVET-W0097 proposes a combination of EE2-3.3, EE2-3.4 and EE2-3.5 to further improve the coding efficiency of the GPM mode. Specifically, in the proposed combination, the existing designs in EE2-3.3, EE2-3.4 and EE2-3.5 are kept unchanged while the following modifications are further applied for the harmonization of the two coding tools:
1) The GPM-MMVD and GPM-TM are exclusively enabled to one GPM CU. This is done by firstly signalling the GPM-MMVD syntax. When both two GPM-MMVD control flags are equal to false (i.e., the GPM-MMVD are disabled for two GPM partitions), the GPM-TM flag is signalled to indicate whether the template matching is applied to the two GPM partitions. Otherwise (at least one GPM-MMVD flag is equal to true), the value of the GPM-TM flag is inferred to be false.
2) The GPM merge candidate list generation methods in EE2-3.3 and EE2-3.4-3.5 are directly combined in a manner that the MV pruning scheme in EE2-3.4-3.5 (where the MV pruning threshold is adapted based on the current CU size) is applied to replace the default MV pruning scheme applied in EE2-3.3; additionally, as in EE2-3.4-3.5, multiple zero MVs are added until the GPM candidate list is fully filled.

In JVET-Y0065, in GPM with inter and intra prediction (or named GPM intra), the final prediction samples are generated by weighting inter predicted samples and intra predicted samples for each GPM-separated region. The inter predicted samples are derived by the same scheme as the GPM in the current ECM whereas the intra predicted samples are derived by an intra prediction mode (IPM) candidate list and an index signalled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown FIGS. 18A-C, respectively. Furthermore, GPM with intra and intra prediction as shown FIG. 18D is restricted in the proposed method to reduce the signalling overhead for IPMs and avoid an increase in the size of the intra prediction circuit on the hardware decoder. In addition, a direct motion vector and IPM storage on the GPM-blending area is introduced to further improve the coding performance.

### Spatial GPM

Similar to inter GPM, Spatial GPM (SGPM) consists of one partition mode and two associated intra prediction modes as shown in FIG. 19A. If these modes are directly signalled in the bit-stream, as shown in FIG. 19B, it would yield significant overhead bits. To express the necessary partition and prediction information more efficiently in the bit-stream, a candidate list is employed and only the candidate index is signalled in the bit-stream. Each candidate in the list can derive a combination of one partition mode and two intra prediction modes, as shown in FIG. 19C.

A template is used to generate this candidate list. The shape of the template is shown in FIG. 20. For each possible combination of one partition mode and two intra prediction modes, a prediction is generated for the template with the partitioning weight extended to the template, as shown in FIG. 20. These combinations are ranked in ascending order of their SATD between the prediction and reconstruction of the template. The length of the candidate list is set equal to 16, and these candidates are regarded as the most probable SGPM combinations of the current block. Both encoder and decoder construct the same candidate list based upon the template.

To reduce the complexity in building the candidate list, both the number of possible partition modes and the number of possible intra prediction modes are pruned. In the following test, 26 out of 64 partition modes are used, and only the MPMs out of 67 intra prediction modes are used.

In JVET-AA0118 (Fan Wang, et. al., “EE2-1.4: Spatial GPM”, Joint Video Experts Team (JVET) of ITU-T SG 16 WP 3 and ISO/IEC JTC 1/SC 29, 27th Meeting, by teleconference, 13-22 Jul. 2022, Document: JVET-AA0118), some schemes to speed up the encoding process of SGPM and improve the gain of SGPM are disclosed and some key techniques related to MIP are reviewed as follows.

### EE2-4.1: Modification of LFNST for MIP Coded Block

In ECM6.0 (Muhammed Coban, et. al., “Algorithm description of Enhanced Compression Model 6 (ECM 6)”, Joint Video Experts Team (JVET) of ITU-T SG 16 WP 3 and ISO/IEC JTC 1/SC 29, 27th Meeting, by teleconference, 13-22 Jul. 2022, Document: JVET-AA202), the LFNST transform set and LFNST transpose flag are both determined by the intra prediction mode predModeIntra of the current transform block. With the predModeIntra, the following operation is conducted:
If the current block is MIP coded block, predModeIntra is mapped to PLANAR;
If the current block is CCLM coded block, predModeIntra is mapped to the co-located luma intra prediction mode;

Then, predModeIntra is further derived from wide angle intra prediction mapping with a range of [−14, 83].

### Selection of LFNST Transform Sets

There are totally 35 transform sets and 3 non-separable transform matrices (kernels) per transform set in LFNST in ECM6.0. The transform set idx lfnstTrSetIdx is defined according to predModeIntra list in Table 4.

TABLE 4
LFNST transform set selection

| | Intra pred. mode | | | | | | | | | | | | | | | |
|---|---|---|---|---|---|---|---|---|---|---|---|---|---|---|---|---|
| | −14 | −13 | −12 | −11 | −10 | −9 | −8 | −7 | −6 | −5 | −4 | −3 | −2 | −1 | 0 | 1 |
| LFNST set index | 2 | 2 | 2 | 2 | 2 | 2 | 2 | 2 | 2 | 2 | 2 | 2 | 2 | 2 | 0 | 1 |

| | Intra pred. mode | | | | | | | | | | | | | | | |
|---|---|---|---|---|---|---|---|---|---|---|---|---|---|---|---|---|
| | 2 | 3 | 4 | 5 | 6 | 7 | 8 | 9 | 10 | 11 | 12 | 13 | 14 | 15 | 16 | 17 |
| LFNST set index | 2 | 3 | 4 | 5 | 6 | 7 | 8 | 9 | 10 | 11 | 12 | 13 | 14 | 15 | 16 | 17 |
| | Intra pred. mode | | | | | | | | | | | | | | | |
| | 18 | 19 | 20 | 21 | 22 | 23 | 24 | 25 | 26 | 27 | 28 | 29 | 30 | 31 | 32 | 33 |
| LFNST set index | 18 | 19 | 20 | 21 | 22 | 23 | 24 | 25 | 26 | 27 | 28 | 29 | 30 | 31 | 32 | 33 |
| | Intra pred. mode | | | | | | | | | | | | | | | |
| | 34 | 35 | 36 | 37 | 38 | 39 | 40 | 41 | 42 | 43 | 44 | 45 | 46 | 47 | 48 | 49 |
| LFNST set index | 34 | 33 | 32 | 31 | 30 | 29 | 28 | 27 | 26 | 25 | 24 | 23 | 22 | 21 | 20 | 19 |
| | Intra pred. mode | | | | | | | | | | | | | | | |
| | 50 | 51 | 52 | 53 | 54 | 55 | 56 | 57 | 58 | 59 | 60 | 61 | 62 | 63 | 64 | 65 |
| LFNST set index | 18 | 17 | 16 | 15 | 14 | 13 | 12 | 11 | 10 | 9 | 8 | 7 | 6 | 5 | 4 | 3 |

| | Intra pred. mode | | | | | | | | | | | | | | |
|---|---|---|---|---|---|---|---|---|---|---|---|---|---|---|---|
| | 66 | 67 | 68 | 69 | 70 | 71 | 72 | 73 | 74 | 75 | 76 | 77 | 78 | 79 | 80 |
| LFNST set index | 2 | 2 | 2 | 2 | 2 | 2 | 2 | 2 | 2 | 2 | 2 | 2 | 2 | 2 | 2 |

### Determination of LFNST Transpose Flag

The LFNST transpose flag determines the scan order of the LFNST output (Decoder). FIGS. 21A-B show the scan order (2110-2160) with different LFNST transpose flag (FIG. 21A for flag equal to 0 and FIG. 21B for flag equal to 1).

The LFNST transpose flag is determined by predModeIntra as follows:
if predModeIntra is less than or equal to 34, the LFNST transpose flag is set to 0;
else, the LFNST transpose flag is set to 1.

For MIP coded blocks, it is mapped to the PLANAR mode, the LFNST transform set 0 is used and LFNST transpose flag is always equal to 0.

In ECM6.0, LFNST is enable for the MIP coded blocks with the width and height greater than or equal to 16.

### Prediction Process of MIP

As mentioned earlier, Matrix weighted intra prediction (MIP) takes one line of H reconstructed neighbouring boundary samples on the left of the block and one line of W reconstructed neighbouring boundary samples above the block as input. The generation of the prediction samples is based on the following three steps: the input 2210 comprising boundary samples (shown as darker squares) around a current block is provided to boundary downsampling module 2220; and then processed by matrix vector multiplication module 2230 to generate MIP prediction 2240; and further processed by MIP prediction upsampling module 2250 to generate the upsampled output 2260 as shown in FIG. 22.

Specifically, MIP first downsamples the reference samples, and then multiplies the downsampled reference samples with the prediction matrix to generate partial prediction samples. Finally, it is upsampled to generate predicted samples at the remaining positions.

### Modification of LFNST for MIP Coded Blocks

In JVET-AB0067 (Junyan Huo, et. al., “EE2-4.1: Modification of LFNST for MIP coded block”, Joint Video Experts Team (JVET) of ITU-T SG 16 WP 3 and ISO/IEC JTC 1/SC 29, 28th Meeting, Mainz, DE, 21-28 Oct. 2022, Document: JVET-AB0067), it is proposed to utilize DIMD to derive the LFNST transform set and determine LFNST transpose flag.

The proposed method uses the DIMD 2310 to derive the intra prediction mode of the current block based on the MIP predicted samples before upsampling. Specifically, a horizontal gradient and a vertical gradient are calculated for each predicted sample to build a HoG 2320, as shown in FIG. 23. Then the intra prediction mode with the largest histogram amplitude values is used to determine the LFNST transform set and LFNST Transpose flag.

Furthermore, LFNST is enabled for MIP coded blocks of width and height greater than or equal to 4.

### Enhanced MTS for Intra Coding

In the current VVC design, for MTS (Multi Transform Selection), only DST7 and DCT8 transform kernels are utilized, which are used for intra and inter coding.

Additional primary transforms including DCT5, DST4, DST1, and identity transform (IDT) are employed. Also MTS set is made dependent on the TU size and intra mode information. 16 different TU sizes are considered, and for each TU size, 5 different classes are considered depending on intra-mode information. For each class, 1, 4 or 6 different transform pairs are considered. Number of intra MTS candidates are adaptively selected (between 1, 4 and 6 MTS candidates) depending on the sum of absolute value of transform coefficients. The sum is compared against the two fixed thresholds to determine the total number of allowed MTS candidates:
1 candidate: sum<=th0,
4 candidates: th0<sum<=th1,
6 candidates: sum>th1.

Note, although a total of 80 different classes are considered, some of those different classes often share exactly the same transform set. So there are 58 (less than 80) unique entries in the resultant LUT.

For angular modes, a joint symmetry over TU shape and intra prediction is considered. So, a mode i (i>34) with TU shape A×B will be mapped to the same class corresponding to the mode j=(68−i) with TU shape B×A. However, for each transform pair the order of the horizontal and vertical transform kernel is swapped. For example, for a 16×4 block with mode 18 (horizontal prediction) and a 4×16 block with mode 50 (vertical prediction) are mapped to the same class. However, the vertical and horizontal transform kernels are swapped. For the wide-angle modes the nearest conventional angular mode is used for the transform set determination. For example, mode 2 is used for all the modes between −2 and −14. Similarly, mode 66 is used for mode 67 to mode 80.

### Chroma DM Mode

For Chroma DM mode, the intra prediction mode of the corresponding (collocated) luma block covering the centre position of the current chroma block is directly inherited.

### Intra Block Copy

Intra block copy (IBC) is a tool adopted in HEVC extensions on SCC (Screen Content Coding). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector is rounded to integer precision as well. When combined with AMVR (Adaptive Motion Vector Resolution), the IBC mode can switch between 1-pel and 4-pel motion vector precisions. An IBC-coded CU is treated as the third prediction mode other than intra or inter prediction modes. The IBC mode is applicable to the CUS with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return a valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP (Advanced Motion Vector Prediction) mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP (History based Motion Vector Prediction), and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### IBC Reference Region

To reduce memory consumption and decoder complexity, the IBC in VVC allows only the reconstructed portion of the predefined area including the region of current CTU and some region of the left CTU. FIG. 6 illustrates the reference region of IBC Mode, where each block represents 64×64 luma sample unit. Depending on the location of the current coded CU within the current CTU, the following applies:
If the current block falls into the top-left 64×64 block of the current CTU (case 2410 in FIG. 24), then in addition to the already reconstructed samples in the current CTU, it can also refer to the reference samples in the bottom-right 64×64 blocks of the left CTU, using current picture referencing (CPR) mode. (More details of CPR can be found in JVET-T2002 (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)). The current block can also refer to the reference samples in the bottom-left 64×64 block of the left CTU and the reference samples in the top-right 64×64 block of the left CTU, using CPR mode.
If the current block falls into the top-right 64×64 block of the current CTU (case 2420 in FIG. 24), then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If the current block falls into the bottom-left 64×64 block of the current CTU (case 2430 in FIG. 24), then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU (case 640 in FIG. 6), it can only refer to the already reconstructed samples in the current CTU, using CPR mode.

In the present invention, methods to improve the performance of intra prediction mode are disclosed.

### BRIEF SUMMARY OF THE INVENTION

A method and apparatus for video coding are disclosed. According to this method, input data associated with a current block are received, wherein the input data comprise pixel data to be encoded at an encoder side or coded data associated with the current block to be decoded at a decoder side. A predefined target mode for the current block is determined, wherein the predefined target mode uses template-based histogram, gradient analysis, template-based distortion calculation, or any-pre-defined prediction derivation based on template of the current block. A first flag for the current block is signalled or parsed to indicate whether to apply a region-based mode derivation process to the current block. In response to the first flag for the current block indicating the region-based mode derivation process being applied: the template is divide into at least two template regions; at least two intra prediction modes are derived from said at least two template regions using a predefined measurement for said at least two template regions respectively, wherein the predefined measurement comprises deriving at least one candidate list comprising at least one of said at least two intra prediction modes; and at least two hypotheses of predictors are derived based on said at least two intra prediction modes. A final predictor is generated based on said at least two hypotheses of predictors. The current block is encoded or decoded using the final predictor.

In one embodiment, the final predictor is derived by blending said at least two hypotheses of predictors. In one embodiment, said at least two hypotheses of predictors are blended on a sample basis. In one embodiment, said at least two intra prediction modes are blended using position-dependent weights. In one embodiment, when said at least two template regions correspond to a top template region and a left template region, a top intra prediction mode and a left intra prediction mode are derived using the top template region and the left template region respectively, and wherein top weights for the top intra prediction mode have larger values for samples closer to the top template region, and/or left weights for the left intra prediction mode have larger values for samples closer to the left template region.

In one embodiment, said at least two template regions correspond to a top template region on top of the current block and a left template region on left of the current block. In one embodiment, a top intra prediction mode and a left intra prediction mode are selected using the top template region and the left template region respectively, and wherein the top intra prediction mode and the left intra prediction mode correspond to a top intra prediction candidate and a left intra prediction candidate achieving smallest template-based distortions calculated using the top template region and the left template region respectively. In one embodiment, the top template region is divided into multiple top sub-regions and/or the left template region is divided into multiple left sub-regions, and wherein the current block is divided into multiple grids horizontally, vertically or both according to the multiple top sub-regions and/or the multiple left sub-regions.

In one embodiment, multiple top subblock intra prediction modes are derived using the multiple top sub-regions respectively and/or multiple left subblock intra prediction modes are derived using the multiple left sub-regions respectively, and wherein a target subblock intra prediction mode is derived for each grid based on a corresponding top subblock intra prediction mode associated with one top sub-region above said each grid and a corresponding left subblock intra prediction mode associated with one left sub-region on left of said each grid. In one embodiment, the target subblock intra prediction mode is derived by blending said one top subblock intra prediction mode and said one left subblock intra prediction mode using weights. In one embodiment, when ISP (Intra Sub-Partition) is applied to the current block, CB (Coding Block) position is used to derive position-dependent weights for blending subblock intra prediction modes. In one embodiment, boundary samples between two adjacent grids are derived by blending predictors generated using subblock intra prediction modes comprising two top subblock intra prediction modes derived for two horizontally adjacent grids, two adjacent left subblock intra prediction modes derived for two vertically adjacent grids, or both.

In one embodiment, the top template region is divided into the multiple top sub-regions and/or the left template region is divided into the multiple left sub-regions when block width, block height, or both of the current block are greater than a threshold.

In one embodiment, at least one of three best modes and/or at least one of three second-best modes are derived based on at least one of both the top template region and the left template region, the top template region only and the left template region only respectively, and wherein a candidate list for a pre-defined template region is determined based on a basic candidate list and adjusted by any subset of one best mode and/or one second-best mode with an offset. In one embodiment, when best modes for a first sub-region and a second sub-region are the same, a best mode for one of the first sub-region and the second sub-region is changed to a second-best mode.

In one embodiment, a second flag is signalled or parsed, and wherein the second flag indicate whether the region-based mode derivation process is applied to the current block. In one embodiment, the second flag is signalled or parsed only when both an above template region and a left template region are available. In another embodiment, the second flag is signalled or parsed only if block width or height of the current block is larger than a threshold.

In one embodiment, an intra prediction mode for the current block is stored and/or referenced by one or more subsequent coding blocks or the intra prediction mode for the current block is stored for pre-defined processing of the current block. In one embodiment, the intra prediction mode stored is used for MPM generation and/or chroma DM (Direct Mode) for said one or more subsequent coding blocks. In another embodiment, the intra prediction mode stored is used for transform process of the current block. In one embodiment, the intra prediction mode is any one of available intra prediction modes comprising DC, planar, angular modes, 67 intra prediction modes, or 131 intra prediction modes. In one embodiment, the intra prediction mode is derived by any of implicit derivation schemes comprising template-based derivation, decoder-side derivation or a combination thereof. In one embodiment, the intra prediction mode corresponds to a best mode or a second-best mode derived by according to TIMD (Template-based Intra Mode Derivation) using both a top template region and a left template region, the top template region only, or the left template region only.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 3 illustrates an example of the signalling mechanism of the partition splitting information in quadtree with nested multi-type tree coding tree structure.

FIG. 4 shows an example of a CTU divided into multiple CUs with a quadtree and nested multi-type tree coding block structure, where the bold block edges represent quadtree partitioning and the remaining edges represent multi-type tree partitioning.

FIG. 5 shows some examples of TT split forbidden when either width or height of a luma coding block is larger than 64.

FIG. 6 shows the intra prediction modes as adopted by the VVC video coding standard.

FIG. 7 illustrates the locations of the neighbouring blocks (L, A, BL, AR, AL) used in the derivation of a general MPM list.

FIGS. 8A-B illustrate examples of wide-angle intra prediction a block with width larger than height (FIG. 8A) and a block with height larger than width (FIG. 8B).

FIG. 9A illustrates an example of selected template for a current block, where the template comprises T lines above the current block and T columns to the left of the current block.

FIG. 9B illustrates an example for T=3 and the HoGs (Histogram of Gradient) are calculated for pixels in the middle line and pixels in the middle column.

FIG. 9C illustrates an example of the amplitudes (ampl) for the angular intra prediction modes.

FIG. 10 illustrates an example of the blending process, where two angular intra modes (M1 and M2) are selected according to the indices with two tallest bars of histogram bars.

FIG. 11 illustrates an example of template-based intra mode derivation (TIMD) mode, where TIMD implicitly derives the intra prediction mode of a CU using a neighbouring template at both the encoder and decoder.

FIG. 12A illustrates an example of Intra Sub-Partition (ISP), where a block is partitioned into two subblocks horizontally or vertically.

FIG. 12B illustrates an example of Intra Sub-Partition (ISP), where a block is partitioned into four subblocks horizontally or vertically.

FIG. 13 illustrates an example of the of 64 partitions used in the VVC standard, where the partitions are grouped according to their angles and dashed lines indicate redundant partitions.

FIG. 14 illustrates an example of uni-prediction MV selection for the geometric partitioning mode.

FIG. 15 illustrates an example of blending weight ω₀ using the geometric partitioning mode.

FIG. 16 illustrates an example of the weight value derivation for Combined Inter and Intra Prediction (CIIP) according to the coding modes of the top and left neighbouring blocks.

FIG. 17 illustrates an example of processing flow for Matrix weighted intra prediction (MIP).

FIGS. 18A-C illustrate examples of available IPM candidates: the parallel angular mode against the GPM block boundary (Parallel mode, FIG. 18A), the perpendicular angular mode against the GPM block boundary (Perpendicular mode, FIG. 18B), and the Planar mode (FIG. 18C), respectively.

FIG. 18D illustrates an example of GPM with intra and intra prediction, where intra prediction is restricted to reduce the signalling overhead for IPMs and hardware decoder cost.

FIG. 19A illustrates an example of Spatial GPM (SGPM), which consists of one partition mode and two associated intra prediction modes.

FIG. 19B illustrates the syntax coding for Spatial GPM (SGPM) before using a simplified method.

FIG. 19C illustrates an example of simplified syntax coding for Spatial GPM (SGPM).

FIG. 20 illustrates an example of template and weights for Spatial GPM (SGPM).

FIGS. 21A-B illustrate the scan orders of the LFNST output with different LFNST transpose flag, where FIG. 21A is for flag equal to 0 and FIG. 21B is for flag equal to 1.

FIG. 22 illustrates an example of processing flow for Matrix weighted intra prediction (MIP).

FIG. 23 illustrates an example of LFNST modification for MIP coded blocks, which utilizes DIMD to derive the LFNST transform set and determine LFNST transpose flag.

FIG. 24 illustrates an example of IBC reference region.

FIG. 25 illustrates an example of neighbouring L-shape reference samples including a top region on the top side of the current block, a left region on a left side of the current block and a top-left region of the current block.

FIG. 26 illustrates an example of neighbouring L-shape reference samples by extending the top region and the left region of the neighbouring L-shape reference samples in FIG. 25.

FIG. 27 illustrates an example of neighbouring L-shape reference samples by excluding the top-left region of the neighbouring L-shape reference samples in FIG. 25.

FIG. 28A illustrates an example of neighbouring L-shape reference samples by only including the top region of the neighbouring L-shape reference samples.

FIG. 28B illustrates an example of neighbouring L-shape reference samples by only including the left region of the neighbouring L-shape reference samples.

FIG. 29 illustrates an example of dividing the top reference region into sub-regions and dividing the left reference region into sub-regions.

FIG. 30 illustrates an example of generating predictors for a sub-region, where the reference samples to generate the predictors are the adjacent L shape of the sub-region.

FIG. 31 illustrates an example of generating predictors for a sub-region, where the reference samples to generate the predictors are the outer L shape of the top and left regions of the current block.

FIG. 32 illustrates an example of partitioning the template region into sub-regions and partitioning the current block into grids accordingly.

FIG. 33 illustrates an example of deriving a total of 8 representative intra prediction modes (denoted as m0, m1, m2, m3, n0, n1, n2, and n3) from the neighbouring suggestion and generating 8 hypotheses of predictions for the current block.

FIG. 34 illustrates an example for this embodiment, where a total of 2 representative intra prediction modes (denoted as m0 and n0) are derived from the neighbouring suggestion and 2 hypotheses of predictions for the current block are generated.

FIG. 35 illustrates an example of the weights of the prediction generated using the intra prediction mode suggested by the above template region for samples in the current block.

FIG. 36 illustrates an example of dividing the current block into several sub-blocks.

FIG. 37 illustrates an example of overlapping regions among subblocks.

FIG. 38 illustrates an example of blending process for the overlapped areas of grid₁₁.

FIG. 39 illustrates an example deriving the position-dependent weights based on CB position when the current block is coded using Intra Sub-Partition.

FIG. 40 illustrates a flowchart of an exemplary video coding system that incorporates region-based intra prediction mode derivation according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In this invention, a novel mechanism of deriving one or more intra prediction modes for the current block is disclosed.

### 1. Neighbouring (L-Shape) Reference Samples

In this invention, a novel mechanism of deriving one or more intra prediction modes for the current block is disclosed. When deriving the one or more intra prediction modes, neighbouring L-shape reference samples (e.g. neighbouring reconstructed and/or predicted samples) and any extension or subset of the neighbouring L-shape reference samples is used. FIG. shows an example of neighbouring L-shape reference samples. The neighbouring L-shape reference samples include top region 2510, left region 2520, and/or top-left region 2530 as shown in FIG. 25. The size (top region width×top region height, denoted as T1×T2) of top region can be set as T1 equal to the block width and T2 equal to a pre-defined positive value as shown in FIG. 25. A similar way is applied to the left region. The size (left region width×left region height, denoted as L1×L2) of left region can be set as L1 equal to a pre-define positive value and L2 equal to the block height as shown in FIG. 25.

There are more variations of using neighbouring L-shape reference samples.

In one embodiment, the extension of the neighbouring L-shape samples is used as extending the top region width and/or extending the left region height. For example, the top region width is extended to k*the block width, where k is larger than 1. Similarly, the left region height is extended to k*the block height, where k is larger than 1.

In another embodiment, the extension of the neighbouring L-shape samples is used as extending the top region width and/or extending the left region height as shown in FIG. 26. The top region width is extended to the block width 2510+a predefined k′ 2610. Similarly, the left region height is extended to the block height 2520+a predefined k″ 2620. k′ and k″ can be set as any positive integers. For example, k′ is the block height and/or k″ is the block width.

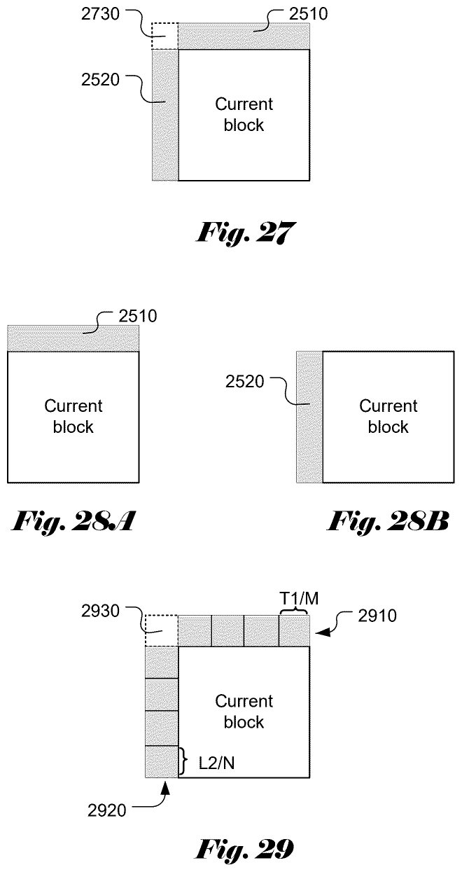

In another embodiment, the subset of the neighbouring L-shape reference samples is used by excluding the top-left region of the neighbouring L-shape reference samples as shown in FIG. 27, where the upper-left region 2730 is removed as shown by a dotted-line box.

In another embodiment, the subset of the neighbouring L-shape reference samples is used by only including the top region of the neighbouring L-shape reference samples as shown in FIG. 28A.

In another embodiment, the subset of the neighbouring L-shape reference samples is used by only including the left region of the neighbouring L-shape reference samples as shown in FIG. 28B.

### 2. Mode Derivation on Neighbouring (L-Shape) Reference Samples

### 2.1. Splitting Methods on Neighbouring (L-Shape) Reference Samples

When deriving the one or more intra prediction modes, the used neighbouring reference samples are divided into one or more sub-regions and a pre-defined derivation method is performed on a sub-region to get a representative intra prediction mode (also named as a target representative intra prediction mode) from the sub-region. Take the following as an example to illustrate the proposed sub-region based intra mode derivation. However, the proposed method is not limited to this specific example. Instead, the proposed method can also be applied to any proposed version of neighbouring reference samples. As shown in FIG. 29, the top reference region is divided into sub-regions 2910 and the left reference region is also divided into sub-regions 2920.

In one embodiment, for the top reference region, a dividing factor M is pre-defined to divide the top reference region into the sub-regions with the sub-region width equal to T1/M as shown in FIG. 29. Similarly, another dividing factor N is pre-defined to divide the left region into the sub-regions with the sub-region height equal to L2/N as shown in FIG. 29. For example, a same value is set to M and N, where M=N=2, 4, 8, or any positive integer. For another example, M and N can be different. For another example, M and/or N can vary with the block width, block height, and/or block area of the current block. If width of the current block is larger than height of the current block, M is larger than N; otherwise, M is smaller than or equal to N. For another example, the dividing factors here will follow or align with the dividing for the current block described in the sections below.

In another embodiment, when M is set equal to 1, that means no dividing process is applied to the top region and the only one sub-region on the top region refers to the top region. Only one representative intra prediction mode is decided from the top region according to the pre-defined implicit derivation scheme. Similarly, when N is set equal to 1, no dividing process is applied to the left region and the only one sub-region on the left region refers to the left region. Only one representative intra prediction mode is decided from the left region according to the pre-defined implicit derivation scheme.

### 2.2. Candidate Lists of Intra Prediction Modes for Each Sub-Region on Neighbouring (L-Shape) Reference Samples

In one embodiment, a basic candidate list is built and is shared for each sub-region. The basic candidate list includes MPMs comprising spatial adjacent candidates and/or spatial non-adjacent candidates, and/or history-based candidates, and/or temporal candidates, and/or propagation candidates, some default intra prediction modes, some derived modes from the promising intra prediction modes, and/or any subset of available intra prediction modes. For example, spatial adjacent candidates can be from the left/above/above-left/above-right/bottom-left neighboring blocks of the current block, the left/above/above-left/above-right/bottom-left neighboring blocks of a target sub-region, and/or any subset of the above-mentioned positions. Spatial non-adjacent candidates can be from any pre-defined positions in a search pattern around the current block, any pre-defined positions in a search pattern around a target sub-region, and/or any subset of the above-mentioned positions. History-based candidates can be from a history buffer which stores multiple intra prediction mode information of the previous coded blocks which were coded before the current block and have valid intra prediction mode information. The history buffer is empty at a pre-defined timing. For example, the history buffer is empty at the beginning or the end of a slice, CTU/CTB, CTU/CTB row, picture, tile, sequence, and/or any pre-defined unit. Temporal candidates can be from a buffer which stores the intra prediction mode information at a referred reference position in the reference frame (or reference picture) and/or a pre-defined collocated picture, and/or stores the intra prediction mode information at any pre-defined positions nearing the referred reference position. For example, the referred reference position is the collocated block in the collocated picture. For another example, the referred reference position is indicated using the motion information of the neighboring blocks or any pre-defined blocks associated with the current block. Propagation candidates can be from the intra prediction mode information at one or more reference positions referring by the motion information of the neighbouring blocks or any pre-defined blocks associated with the current block. For example, available intra prediction modes can be any subset of available intra prediction modes in video coding standard (e.g. VVC) or developing video coding software (e.g. ECM) such as 67 intra prediction modes, 131 intra prediction modes. For another example, the default intra prediction modes can be some popular intra prediction modes such as any subset of DC, planar, horizontal, vertical, diagonal, inverse diagonal intra prediction modes. For example, the derived modes from the promising intra prediction modes include the derived modes from Gi where i=0, 1, 2, 3, 4 and/or 5. The range of the mode index of a derived mode will be within (the mode index of the Gᵢ+/−a predefined positive integer offset).

G₀ is selected among all or any subset of candidates in the basic candidate list with all or any subset of the derived modes excluded and G₀ means the best intra prediction mode obtained by performing a pre-defined implicit derivation scheme (which will be described later) on both the whole top and whole left regions. G₁ is determined with the same method as G₀ but G₁ is the second best intra prediction mode.

G₂ is selected among all or any subset of candidates in the basic candidate list with all or any subset of the derived modes excluded and G₂ means the best intra prediction mode obtained by performing a pre-defined implicit derivation scheme (which will be described later) on only the whole top region. G₃ is determined with the same method as G₂ but G₃ is the second best intra prediction mode.

G₄ is selected among all or any subset of candidates in the basic candidate list with all or any subset of the derived modes excluded and G₄ means the best intra prediction mode obtained by performing a pre-defined implicit derivation scheme (which will be described later) on only the whole left region. G₅ is determined with the same method as G₄ but G₅ is the second best intra prediction mode.

In one sub-embodiment, for each pre-selected sub-region, the basic candidate list is further modified. Each pre-selected sub-region has its own candidate list. For example, the pre-selected sub-regions include one or more sub-regions on only the left region. For another example, the pre-selected sub-regions include one or more sub-regions on only the above (top) region. For another example, the pre-selected sub-regions include one or more sub-regions on both the left and above regions.

In another sub-embodiment, the basic candidate list refers to the candidate intra prediction modes for original TIMD mode. The proposed methods use unified candidate intra prediction modes with original TIMD mode.

In another embodiment, a candidate list is defined for each sub-region. For example, the candidate list can first include the basic candidate list. After the following examples, the candidate list for each sub-region can be the same or different.
For example, the derived modes of the representative intra prediction mode, with the mode index ranging in (the mode index of the representative intra prediction mode+/−a predefined positive integer offset), from the previous sub-region can be added into the candidate list for the current sub-region.
For another example, the candidate list for each sub-region includes the derived modes with mode index ranging in {Gᵢ−offset1, Gᵢ+offset2}, where offset1 and offsest2 can be the same or different for each sub-region.
   Offset1 and offsest2 can vary with the block width, height, or area.
   Offset1 and offsest2 can vary with the sub-region width, height, or area.
   Offset1 and offsest2 can vary with the calculated costs of the candidate mode. For the current sub-region, if the calculated costs (using in the pre-define implicit derivation scheme) are all larger than a pre-defined number (e.g. sub-region size), more candidate modes are needed and offset1 and/or offset2 are increased. If any calculated cost is smaller than a pre-defined number (e.g. sub-region size), less candidate modes are needed and offset1 and/or offset2 are reduced.

In another embodiment, two candidate lists are designed for the one or more sub-regions in the top region and the one or more sub-regions in the left region, respectively. Each sub-region in the top region uses one candidate list and each sub-region in the left region uses the other candidate list. If the pre-defined implicit derivation scheme is first performed on the left (or above) region, the representative intra prediction modes from left (or top) region and/or the derived modes of the representative intra prediction modes from left (or top) region are added into the candidate list for top (or left) region.

### 2.3. Pre-Defined Implicit Derivation Scheme on a Target Region

The scheme can be a TIMD-like scheme or a DIMD-like scheme. For the example of a TIMD-like scheme, an example of the derivation scheme is shown as follows. First, generate predictors and calculate TIMD costs for each candidate mode (in the candidate list for the target region) on the target region as what original TIMD mode does. The intra prediction parameters (such as whether to apply PDPC, intra interpolation filter, . . . ) for generating predictors are unified with what the original TIMD mode does. The TIMD costs are based on the distortions between the generated predictors and the reference samples within the target region. The distortion measurement metrics may be any pre-defined matrix, SAD, and/or SATD. Second, get the representative intra prediction mode from the target region by using the intra prediction mode with the best (smallest) TIMD cost among the candidate list. (In some cases in the next sub-section, the intra prediction mode with the second best TIMD cost is used instead.) When the target region is the whole top region, one representative intra prediction mode is obtained from the top region. When the target region is a sub-region in the whole top region (including 4 sub-regions in the top region), one representative intra prediction mode is from each sub-region within the top region. Similar way is used for the left region.

For the example of a DIMD-like scheme, instead of calculating TIMD costs, gradient calculation is performed on the target region to get the representative intra prediction mode. The following embodiments focus on using a TIMD-like scheme. However, the disclosed novel scheme is not limited to using with a TIMD-like scheme.

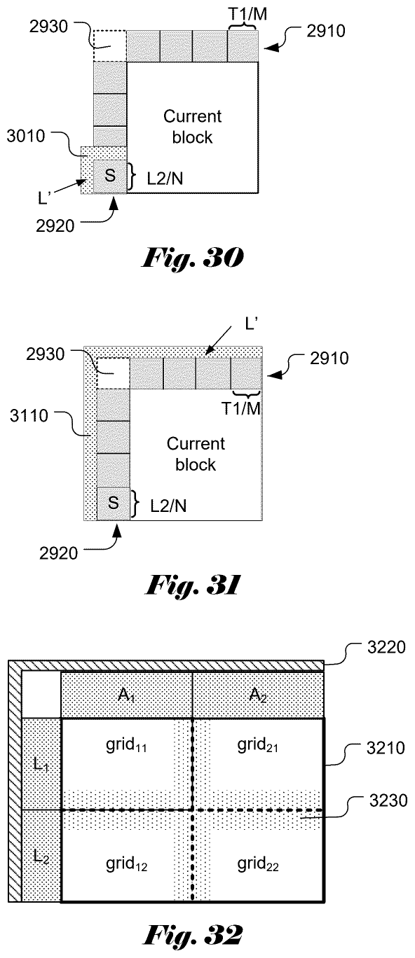

In another embodiment, when generating predictors on the target region, the reference samples to generate the predictors are the adjacent L shape of the target region. If the target region is the sub-region (denoted as S in FIG. 30), the adjacent L is L′ in the following figure. Then for each target region, the cost of a certain candidate intra prediction mode is calculated by measuring the difference between the reconstructed samples and predicted samples at the target region.

In another embodiment, when generating predictors on the target region, the reference samples to generate the predictors are the outer L shape of the top and left regions. If the target region is the sub-region (denoted as S in FIG. 31), the outer L is L′ labelled as 3110 in FIG. 31. In implementation, the predictors for the top region and left region are generated by using the outer L. Then for each target region, the cost of a certain candidate intra prediction mode is calculated by measuring the difference between the reconstructed samples and predicted samples at the target region.

### 2.4. Mode Replacement Scheme

When at least two representative intra prediction modes are derived to generate the prediction for the current block, some redundancy may occur when duplicated intra prediction modes exist in the representative intra prediction modes. The mode replacement scheme is used to remove the redundancy or make the proposed novel scheme efficient.

In one embodiment for the case with only one representative intra prediction mode (denoted as modeA) from above region (denoted as A) and only one representative intra prediction mode (denoted as modeL) from left region (denoted as L), if modeA is the same as modeL, the redundancy occurs and may need the mode replacement scheme. An example of the above region (1112) and left region (1114) for TIMD cost calculation is shown in FIG. 11. For example, the mode replacement is to compare the TIMD cost (denoted as costA) on A and the TIMD cost (denoted as costL) on L and then replace the mode with the larger TIMD cost with the second best mode. After the mode replacement, modeA and modeL are different. If costA is larger than costL, the original modeA (referring to the best mode on the above region) is replaced with the second best mode on the above region. If costL is larger than or equal to costA, the original model (referring to the best mode on the left region) is replaced with the second best mode on the left region.

In one sub-embodiment, when doing the comparing on TIMD costs, the TIMD costs are normalized first if those TIMD costs are from different size of regions.

In another embodiment for the case with two representative intra prediction modes (denoted as modeA₁ and modeA₂) from above region and two representative intra prediction modes (denoted as modeL₁ and modeL₂) from left region, in the following examples, the redundancy occurs and may need the mode replacement scheme.

For the example of modeA₁ being the same as modeA₂ when checking the top region, the mode replacement is to use the pre-defined representative intra prediction mode (such as anyone of A₁, A₂, and Gₖ′ where k=0, 1, 2, or 3) for the whole top region, not to divide on the top region, and/or not to do vertical dividing on the current block. While Gₖ (described in Section 2.2 previously) is a best mode selected from the original candidate list, a Gₖ′ mentioned above corresponds to a derived mode of Gₖ, where Gₖ′ is the best mode selected from the updated candidate list. Various embodiments of the updated candidate list are disclosed as follows.

In one embodiment, a candidate list is defined for each sub-region. For example, the candidate list can first include the basic candidate list. After an updating process as shown in the following examples, the candidate list for each sub-region can be the same or different.

For example, the derived modes of the representative intra prediction mode, with the mode index ranging in (the mode index of the representative intra prediction mode +/−a predefined positive integer offset) from the previous sub-region can be added in the candidate list for the current sub-region.

For another example, the candidate list for each sub-region includes the derived modes with mode index ranging in {Gᵢ−offset1, Gᵢ+offset2}, where offset1 and offsest2 can be the same or different for each sub-region. For example:
Offset1 and offsest2 can vary with the block width, height, or area.
Offset1 and offsest2 can vary with the sub-region width, height, or area.
Offset1 and offsest2 can vary with the calculated costs of the candidate mode.

For the current sub-region, if the calculated costs (using in the pre-define implicit derivation scheme) are all larger than a pre-defined number (e.g. sub-region size), more candidate modes are needed and offset1 and/or offset2 are increased. If any calculated cost is smaller than a pre-defined number (e.g. sub-region size), less candidate modes are needed and offset1 and/or offset2 are reduced.

For the example of modeL₁ being the same as modeL₂ when checking the left region, the mode replacement is to use the pre-defined representative intra prediction mode (such as any one of L₁, L₂, and Gₖ′ where k=0, 1, 4, or 5) for the whole left region, not to divide on the left region, and/or not to do horizontal dividing on the current block.

For the example of the representative intra prediction modes from the sub-regions in the top region being not much better than the pre-defined representative intra prediction mode (such as any one of Gₖ′ where k=0, 1, 2, or 3) from the whole region, the mode replacement is to use the pre-defined representative intra prediction mode (such as any one of Gₖ′ where k=0, 1, 2, or 3) for the whole region, not to divide on the above region, and/or not to do vertical dividing on the current block. This case may happen when (K*the summation of the TIMD cost from each sub-region in the top region) being larger than the TIMD cost of the pre-defined representative intra prediction mode. K can be any pre-defined value. For example, K is set as 2 or any value larger than 1.

For the example of the representative intra prediction modes from the sub-regions in the left region being not much better than the pre-defined representative intra prediction mode (such as any one of Gₖ′ where k=0, 1, 4, or 5) from the whole region, the mode replacement is to use the pre-defined representative intra prediction mode (such as any one of Gₖ′ where k=0, 1, 4, or 5) for the whole region, not to divide on the left region, and/or not to do horizontal dividing on the current block. This case may happen when (K*the summation of the TIMD cost from each sub-region in the left region) being larger than the TIMD cost of the pre-defined representative intra prediction mode. K can be any pre-defined value. For example, K is set as 2 or any value larger than 1.

For the example of modeAᵢ being the same as modeLⱼ when checking gridᵢⱼ, (dividing a block into grids will be described in the next section), the mode replacement is to compare the TIMD cost (denoted as costAᵢ) on Aᵢ and the TIMD cost (denoted as costLⱼ) on Lⱼ and then replace the mode with the larger TIMD cost with the second best mode. After the mode replacement, modeAᵢ and modeLⱼ are different. If costAᵢ is larger than costLⱼ, the original modeAᵢ (referring to the best mode on Aᵢ) is replaced with the second best mode on Aᵢ. If costLⱼ is larger than or equal to costAᵢ, the original modeLⱼ (referring to the best mode on Lⱼ) is replaced with the second best mode on Lⱼ.

In one sub-embodiment, during comparing TIMD costs, the TIMD costs are normalized first if those TIMD costs are from different size of sub-regions.

In another sub-embodiment, the above examples can be combined with any pre-defined order. In one case, those examples, which affect whether to divide a region/current block, should be applied before other examples. In another case, those examples should be done before generating prediction for the current block.

### 2.3. Prediction Generation for the Current Block

In one embodiment, the prediction of current block is generated based on the at least two intra prediction modes. The current block is divided into one or more grids. The dividing on the neighbouring reference samples is aligned with the dividing on the current block. Then, predictors for each grid (denoted as gridᵢⱼ) are the blended predictors based on multiple hypotheses of predictions. In one embodiment, the hypotheses of predictions at least include one hypothesis of prediction generated using the intra prediction mode (denoted as modeAᵢ) from the above neighbouring sub-region (denoted as Aᵢ) and another hypothesis of prediction generated using the intra prediction mode (denoted as modeLⱼ) from the left neighbouring sub-region (denoted as Lⱼ). An example of dividing a current block 3210 into 2×2 grids (grid₁₁, grid₁₂, grid₂₁, grid₂₂) is shown in FIG. 32. The reference data 3220 are used for deriving the prediction samples for the templates. The overlapped areas among the grids are indicated by light dot-filled area 3230. In this example, the top region and the left region are used as the neighbouring reference samples. The above region is divided into two sub-regions, A₁ and A₂. The left region is also divided into two sub-regions, L₁ and L₂. Then, modeA₁, modeA₂, modeL₁, and modeL₂ are derived from A₁, A₂, L₁, and L₂, respectively. For grid₁₁, the predictors are the blended predictors based on multiple hypotheses of predictions, including one hypothesis generated by modeA₁ and another hypothesis generated by modeL₁. Similar way is applied to the remaining grids. For grid₁₂, the predictors are the blended predictors based on multiple hypotheses of predictions, including one hypothesis generated by modeA₁ and another hypothesis generated by modeL₂. For grid₂₁, the predictors are the blended predictors based on multiple hypotheses of predictions, including one hypothesis generated by modeA₂ and another hypothesis generated by modeL₁. For grid₂₂, the predictors are the blended predictors based on multiple hypotheses of predictions, including one hypothesis generated by modeA₂ and another hypothesis generated by modeL₂.

When generating the predictors of the current block, a weighting scheme (including weight for each hypothesis) is designed to blend one or more hypotheses of predictions from one or more representative intra prediction modes. Finally, a right-shifting process and/or a rounding factor are needed. If the summation of the weights is 64, adding a rounding factor equal to 32 and then right-shifting 6 bits are required after blending.

In one embodiment, first of all, generate a hypothesis of prediction for the current block (or one or more subblocks in the current block) according to each representative intra prediction mode. FIG. 33 illustrates an example of subblock based prediction mode derivation. If totally there are 8 representative intra prediction modes (denoted as m0, m1, m2, m3, n0, n1, n2, and n3) from the neighbouring suggestion, 8 hypotheses of predictions for the current block are generated. Then, blend those hypotheses of predictions for the current block according to a predefined weighting scheme.

In one sub-embodiment, the weighting is sample-based. That is, each sample will derive their own weight. The weighting includes the weight for each hypothesis of prediction. For example, p(x, y)=w0(x,y)*p0(x,y)+w1(x,y)*p1(x, y)+w₂(x,y)*p2(x, y)+ . . . +w7(x,y)*p7(x, y), where (x, y) is the sample position in the current block, p(x, y) is the blended predictor at (x, y), pᵢ(x,y) is the to-be-blended predictor for (x, y) from the hypothesis i and wᵢ(x,y) is the weight for pᵢ(x,y). The weight depends on the sample position within the current block, the block width or height of the current block, the cost of the representative intra prediction mode, and/or the distance between the sample position and the corresponding region which recommends the representative intra prediction for generating hypothesis i of prediction.

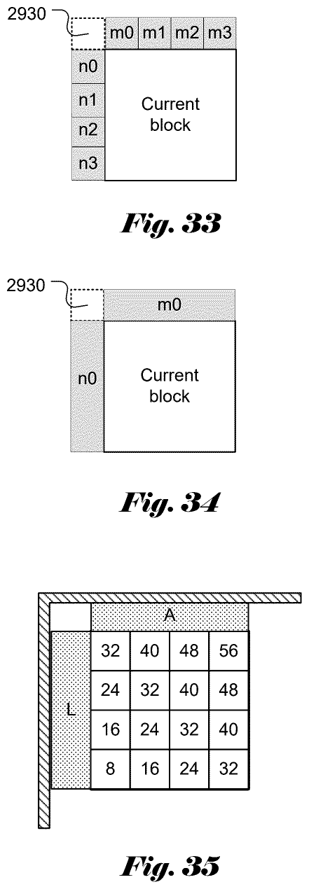

In another embodiment, first of all, generate a hypothesis of prediction for the current block (or one or more subblocks in the current block) according to each representative intra prediction mode. FIG. 34 illustrates an example of generating a hypothesis of prediction for the current block (or one or more subblocks in the current block) according to each representative intra prediction mode. If there are 2 representative intra prediction modes (denoted as m0 and n0) in total from the neighbouring suggestion, 2 hypotheses of predictions for the current block are generated. Then, blend those hypotheses of prediction for the current block according to a predefined weighting scheme.

In one sub-embodiment, the weighting is sample-based. That is, each sample will derive their own weight. The weighting includes the weight for each hypothesis of prediction. For example, p(x, y)=w0(x,y)*p0(x,y)+w1(x,y)*p1(x, y), where (x, y) is the sample position in the current block, p(x, y) is the blended predictor at (x, y), pᵢ(x,y) is the to-be-blended predictor for (x, y) from the hypothesis i and wᵢ(x,y) is the weight for pᵢ(x,y). The weight depends on the sample position within the current block, the block width or height of the current block, the cost of the representative intra prediction mode, and/or the distance between the sample position and the corresponding region which recommends the representative intra prediction for generating hypothesis i of prediction. For example, p0 is generated by m0 (the representative intra prediction mode from A) and p1 is generated by n0 (the representative intra prediction mode from L). w0 (x, y) can be I+(I*x)/W−(I*y)/H, where I depends on the pre-defined summation of weights. w1 is (the summation of weights)−w0. If the summation of weighting is 64, I=half of 64=32. The following numbers mean the w0(x, y) for the sample (x, y) in the current block generated following the above method. An example of the position-dependent weights of p0 for samples in the current block are shown in FIG. 35.

In some cases, the weight will further depend on the costs of the representative intra prediction modes. The cost of m0 is first normalized/scaled according to the top region area/size and the cost of n0 is first normalized/scaled according to the left region area/size. Then, if the cost for m0 is much larger than the cost from n0, w0 is reduced. For example, w0 is reduced as I+ (I*x)/W−(2*I*y)/H. If the cost for no is much larger than the cost from m0, w0 is increased. For example, w0 is reduced as I+(2*I*x)/W−(I*y)/H.

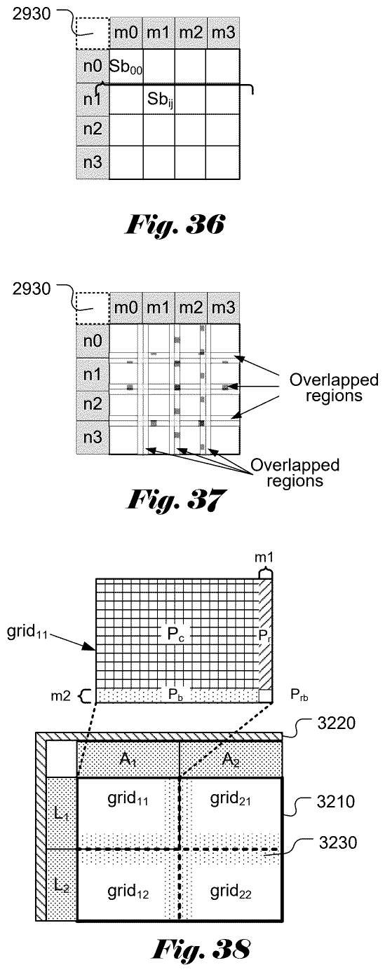

In another embodiment, the current block is divided into several sub-blocks. Each subblock will get one or more representative intra prediction modes from its corresponding one or more reference sub-region. FIG. 36 illustrates an example of a 64×64 block. The 64×64 block is divided into 16 subblocks (denoted as sbᵢⱼ where i=0, 1, 2, or 3 and j=0, 1, 2, or 3). For sb₀₀, its corresponding reference sub-regions include one sub-region from top region and the other sub-region from left region, Therefore, sb₀₀ will get one representative intra prediction mode (denoted as m0) and the other representative intra prediction mode (denoted as n0). Similarly, sb₀₁ will get m0 and n1, sb₁₀ will get m1 and n0, etc.

In one sub-embodiment, the weighting is sample-based. That is, each sample will derive its own weight. The weighting includes the weight for each hypothesis of prediction. Take sb₀₀ as an example. p(x, y)=w0(x,y)*p0(x,y)+w1(x,y)*p1(x, y), where (x, y) is the sample position in the current block, p(x, y) is the blended predictor at (x, y), pᵢ(x,y) is the to-be-blended predictor for (x, y) from the hypothesis i and wᵢ(x,y) is the weight for pᵢ(x,y). The weight depends on the sample position within the current block, the block width or height of the current block, the cost of the representative intra prediction mode, and/or the distance between the sample position and the corresponding region which recommends the representative intra prediction for generating hypothesis i of prediction. For example, p0 is generated by m0 and p1 is generated by n0. w0 (x, y) can be I+(I*x)/W−(I*y)/H, where I depends on the pre-defined summation of weights. w1 is (the summation of weights)−w0. If the summation of weighting is 64, I=half of 64=32.

In some cases, the weight will further depend on the costs of the representative intra prediction modes. The cost of m0 is first normalized/scaled according to the top sub-region area/size and the cost of n0 is first normalized/scaled according to the left sub-region area/size. Then, if the cost for m0 is much larger than the cost from n0, w0 is reduced. For example, w0 is reduced as I+ (I*x)/W−(2*I*y)/H. If the cost for no is much larger than the cost from m0, w0 is increased. For example, w0 is reduced as I+(2I*x)/W−(I*y)/H.

In another sub-embodiment, when dividing the current block into subblocks, the prediction in the overlapping region will be further blended with the predictions generated by the neighbouring used intra prediction modes. An example of overlapping regions among subblocks are shown in FIG. 37. For example, for sb₀₁, in additional to the original predicted samples in sb₀₁ (from m0 and n1), the overlapping region in the upper portion within sb₀₁ will further blend with the prediction generated according to n0. The blending weight (e.g. 1) for the prediction from no will be smaller than the blending weight (e.g. 3) for the original predicted samples.

Take two representative intra prediction modes (denoted as modeA₁ and modeA₂) from above region and two representative intra prediction modes (denoted as modeL₁ and modeL₂) from left region to show more details of blending on the overlapping region. Take grid₁₁ as an example and m1 and m2 are predefined overlapping sizes as shown in FIG. 38, where m1 and m2 can be any predefined positive integers (such as 2) or vary with the block width or height. Larger block width may use larger m1 (such as 4) and large block height may use larger m2 (such as 4). (x, y) is the sample position in the current block. P_{c} is the blending prediction in the current grid and outside from the overlapping region in the current grid. Pᵣ is the blending prediction in the right overlapping region of the current grid. Pb is the blending prediction in the bottom overlapping region of the current grid. P_{rb} is the blending prediction in the right-bottom overlapping region of the current grid. For implementation, one way is to prepare each hypothesis of prediction for all samples in the current block and to use weighting to control the contribution of each hypothesis on different grids and/or overlapping area. Another way is for each non-boundary grid (with size equal to gridW× gridH), to prepare the hypotheses (with each size equal to (gridW+m1)×(gridH+m2)) for this grid and its outer adjacent overlapping area (such as preparing hypotheses from modeA₁ and modeL₁ for grid₁ and its outer adjacent overlapping area); similarly for each boundary grid (with size equal to gridW× gridH), to prepare the hypotheses for this grid and only its outer adjacent overlapping area within the current block; then to use weighting to control the contribution of each hypothesis on different grids and/or overlapping area.

$${P}_{c} ( x , y ) = blending prediction ( x , y ) from {ModeA}_{1} and {ModeL}_{1}$$

$${P}_{r} ( x , y ) = 48 * ( blending prediction ( x , y ) from {ModeA}_{1} and {ModeL}_{1} ) + 16 * ( blending prediction ( x , y ) from {ModeA}_{2} and {ModeL}_{1} ) + 32 ) >> 6$$

$${P}_{b} ( x , y ) = ( 48 * ( blending prediction ( x , y ) from {ModeA}_{1} and {ModeL}_{1} ) + 16 * ( blending prediction ( x , y ) from {ModeA}_{1} and {ModeL}_{2} ) + 32 ) >> 6$$

$${P}_{rb} ( x , y ) = ( 32 * ( blending prediction ( x , y ) from {ModeA}_{1} and {ModeL}_{1} ) + 16 * ( blending prediction ( x , y ) from {ModeA}_{2} and {ModeL}_{1} ) + 16 * ( blending prediction ( x , y ) from {ModeA}_{1} and {ModeL}_{2} ) + 32 ) >> 6$$

where (x, y) is the position in the current block and the blending prediction (x, y) from ModeX and ModeY with (X, Y) set as (A₁, L₁), (A₂, L₁), or (A₁, L₂) is the resulting predicted value at the position (x, y), which is generated by blending the predicted value at the position (x, y) using ModeX and the predicted value at the position (x, y) using ModeY.

In another sub-embodiment, a general representative intra prediction mode is decided according to both top and left whole region. A hypothesis of prediction generated from the general representative intra prediction mode is further blended with the predicted samples in the current block.

In another sub-embodiment, when dividing the current block into several subblocks, the size of each subblock is pre-defined. For example, the size of a subblock is 4×4.

In another sub-embodiment, when dividing the current block into several subblocks, the total number of subblocks is pre-defined. For example, the total number of subblocks is 4×4, so the size of each subblock is (the block width/4)×(the block height/4).

In another embodiment, when generating prediction for the current block, one or more reference lines of intra prediction is determined by the MRL (Multiple Reference Lines) index.

In one sub-embodiment, for the single mode case of TIMD and/or using the proposed novel scheme, at least one (or only one) hypothesis of prediction is generated as a blending prediction from at least two reference lines. The blending prediction may be obtained through blending predicted signals (one from one reference line and another from another reference line) or through generating prediction by referencing the blended reference line. If two reference lines are used, the first line is the line indicated with the MRL index and the second line is the line outer-adjacent to the first line.

In another sub-embodiment, for the non-single mode cases of TIMD and/or using the proposed novel scheme, all hypotheses of prediction is generated by using the only one reference line (indicated by the MRL index).

### 2.4. Mode Propagation of the Proposed Methods

When the proposed novel scheme is used for the current block, a to-be-propagated (or to-be-determined) intra prediction mode can be stored and/or be referenced by the subsequent coding blocks or the following pre-defined process of the current block. For example, to-be-propagated intra prediction mode can be used in the MPM generation/chroma DM for the subsequent coding blocks. For example, to-be-propagated intra prediction mode can be used in the following pre-defined transform process (e.g. primary transform such as DCT-II and/or Multiple Transform Selection (MTS), and/or non-separable primary transform, secondary transform such as Low Frequency Non-Separable Transform (LFNST)) of the current block. For an example of using for MTS, which includes multiple transform sets and/or multiple combinations of horizontal and vertical transforms in each transform set, the to-be-referenced intra prediction mode is used to select or determine the transform set for the current block, and/or the to-be-referenced intra prediction mode is used to select a combination from the transform set and/or to determine the order of combinations in the transform set. For an example of using for non-separable primary transform and/or secondary transform, the to-be-referenced intra prediction mode is used to select the transform set for the current block, and/or the to-be-referenced intra prediction mode maps to a transform set through a pre-defined table, and/or the transpose flag is determined using the to-be-referenced intra prediction mode. In one embodiment, the to-be-propagated intra prediction mode is determined and/or stored, and/or the to-be-propagated intra prediction mode may or may not be referenced by the pre-defined process of the current block and/or subsequent coding blocks.

In one embodiment, the to-be-propagated intra prediction mode can be pre-defined as any one of available intra prediction modes such as DC, planar, angular modes, 67 intra prediction modes, 131 intra prediction modes.

In another embodiment, the to-be-propagated intra prediction mode can be pre-defined as any one of Gₖ, G′ₖ, and the best intra prediction mode from the original TIMD.

For another example of only one representative intra prediction mode (denoted as modeA) from above region (denoted as A) and only one representative intra prediction mode (denoted as modeL) from left region (denoted as L), the final representative intra prediction mode selected from either the above region or the left region is used. The selection may depend on the TIMD costs of intra prediction modes. The intra prediction mode with a smaller TIMD cost is selected. Note that when comparing the TIMD costs, the TIMD costs are normalized first if those TIMD costs are from different size of regions.

For another example of two representative intra prediction modes (denoted as modeA₁ and modeA₂) from above region and two representative intra prediction modes (denoted as modeL₁ and model₂) from left region, the final representative intra prediction mode selected from either one of the above sub-region (such as rightmost sub-region A₂) or one of the left sub-region (such as bottommost sub-region L₂) is used. The selection may depend on the TIMD costs of intra prediction modes. The intra prediction mode with a smaller TIMD cost is selected. Note that when doing the comparing on TIMD costs, the TIMD costs are normalized first if those TIMD costs are from different size of sub-regions.

In another embodiment, since multiple intra prediction modes are used to generate the prediction of the current block when the proposed novel scheme is used, to-be-propagated intra prediction mode used in transform process may not be a good mode to represent the prediction/residual distribution and find the corresponding transform kernel. Therefore, an additional predefined implicit derivation scheme (e.g. TIMD, DIMD, . . . ) may need to perform on all or any subset of the predicted samples for the current block to derive a to-be-propagated intra prediction mode.

### 2.5. Enabling Conditions of the Proposed Methods

In one embodiment, the proposed novel mechanism is enabled and/or disabled according to implicit rules (e.g. block location with the top and left regions being both available, block width, height, or area) or according to explicit rules (e.g. syntax on block, tile, slice, picture, SPS, or PPS level). For example, an additional flag is signalled to indicate whether to apply the proposed novel mechanism to the current block. For another example, the proposed novel mechanism is treated as an optional mode of TIMD. Therefore, when TIMD flag indicates to use TIMD for the current block, the proposed flag is then signalled.

The implicit rule to enable the proposed region-based or grid-based mode can be based on the block width or height. For example, the block width or height can be compared with a threshold to determine whether to enable the proposed region-based or grid-based mode implicitly. The enabling condition of dividing here associated with costs can be used together with the enabling condition of dividing associated with the block width, block height, and/or block area. For example, when the block width is larger than a pre-defined threshold and the enabling condition of dividing here associated with costs are both satisfied, dividing can be applied on the above region, and/or vertical dividing can be applied on the current block. For example, when the block height is larger than a pre-defined threshold and the enabling condition of dividing here associated with costs are both satisfied, dividing can be applied on the left region, and/or horizontal dividing can be applied on the current block. An example for implicitly controlling the grid-based mode is shown as follows.
When the Above template is used:
   If “W>4” and “2*(costA₁+costA₂)<=costA”, then use the grid-based scheme
   Otherwise, use the basic region-based scheme.
When the Above template is used:
   If “H>4” and “2*(costL₁+costL₂)<=costL”, then use the grid-based scheme
   Otherwise, use the basic region-based scheme.

When only vertical dividing is applied (for example, the block width larger than a pre-defined threshold and/or the block height not larger than the pre-defined threshold), only the top reference region is divided into sub-regions and/or the current block is vertically divided into grids. When only horizontal dividing is applied (for example, the block height larger than a pre-defined threshold and/or the block width not larger than the pre-defined threshold), only the left reference region is divided into sub-regions and/or the current block is horizontally divided into grids.

In one sub-embodiment, the proposed flag is signalled when the top and left regions are both available.

In another embodiment, when the proposed novel scheme is applied to the current block, the dividing on the above region (e.g. how many sub-regions on the above region) and/or whether to divide on the above region depend on the block width. For example, when the block width is larger than a predefined threshold (such as 4, 8, or 16), the dividing on the above region is applied and/or the above region is divided into 2 sub-regions.

In another embodiment, when the proposed novel scheme is applied to the current block, the dividing on the left region (e.g. how many sub-regions on the left region) and/or whether to divide on the left region depend on the block height. For example, when the block height is larger than a predefined threshold (such as 4, 8, or 16), the dividing on the left region is applied and/or the left region is divided into 2 sub-regions.

In another embodiment, when the block width, height, or area is larger than a pre-defined threshold (e.g. 4, 8, 16, 32, 64, or 1024), when the TIMD flag is true, the proposed novel scheme is used to replace the original TIMD.

In one sub-embodiment, in this case, no need to create an additional flag to indicate whether to use the proposed novel scheme and can use the proposed novel scheme when the TIMD flag is true.

In another embodiment, TIMD can support more block sizes. For example, when the block width, height, or area is larger than a pre-defined threshold (e.g. 4, 8, 16, 32, 64, or 1024), TIMD can still be supported. (Originally, TIMD is not supported for very large block sizes.) No size constraint exists for TIMD.

In one sub-embodiment, the TIMD size enabling condition is unified regardless slice types. That is, for both intra and inter slices, same size enabling condition is used for TIMD.

In another embodiment, any proposed methods or any combinations of the proposed methods can be applied to luma, chroma components and/or other intra modes (not restricted to TIMD/DIMD) such as normal intra mode, WAIP, intra angular modes, ISP, MIP, SGPM (may using TIMD to derive one or more intra prediction modes), any intra mode specified in the VVC or HEVC, and/or any non-intra mode (e.g. CIIP (may using TIMD to derive one or more intra prediction modes), IBC, GPM (may using TIMD to derive one or more intra prediction modes), inter modes, . . . ).

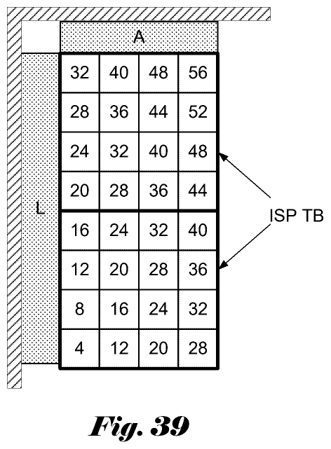

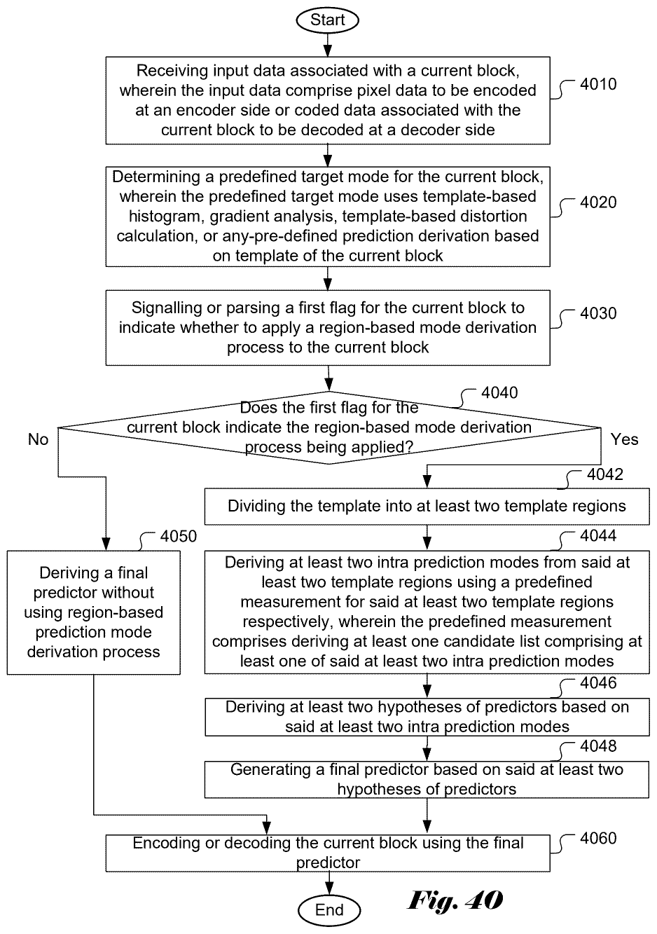

In another sub-embodiment, when supporting the proposed scheme with ISP or any intra mode which may divide the current block (such as current coding block) into multiple sub-blocks (such as transform blocks), the position (x, y) used to derive the weighting for blending refers to the position in the current block (not the position in the sub-blocks). As shown in FIG. 39, the weighting is sample-based following the weighting methods as described above, where each sample will derive its own weight.

“The weighting includes the weight for each hypothesis of prediction. For example, p(x, y)=w0(x,y)*p0(x,y)+w1(x,y)*p1(x, y), where (x, y) is the sample position in the current block, p(x, y) is the blended predictor at (x, y), pᵢ(x,y) is the to-be-blended predictor for (x, y) from the hypothesis I and wᵢ(x,y) is the weight for pᵢ(x,y). The weight depends on the sample position within the current block, the block width or height of the current block, the cost of the representative intra prediction mode, and/or the distance between the sample position and the corresponding region that is used to derive the representative intra prediction for generating hypothesis I of prediction. For example, p0 is generated by m0 (the representative intra prediction mode from A) and p1 is generated by n0 (the representative intra prediction mode from L). w0 (x, y) can be I+ (I*x)/W−(I*y)/H, where I depends on the pre-defined summation of weights. W1 is (the summation of weights)−w0. If the summation of weighting is 64, I=half of 64=32.

The numbers in FIG. 39 mean the w0(x, y) for the sample (x, y) in the current block generated following the above method. To be more specifically, the number equal to 16 is derived by x equal to 0 and y equal to 4 (the position in the current block, called CB position) instead of x equal to 0 and y equal to 0 (the position in the transform block, referring the bottom ISP TB). The motivation of using CB position is that the reference regions are around the current block (not around the transform block); therefore, using CB position can make a larger weight for the representative intra prediction mode from a near reference region (either top region or left region).

The proposed methods in this invention can be enabled and/or disabled according to implicit rules (e.g. block width, height, or area) or according to explicit rules (e.g. syntax on block, tile, slice, picture, SPS, or PPS level). For example, the proposed method is applied when the block area is smaller/larger than a threshold.

The term “block” in this invention can refer to TU/TB, CU/CB, PU/PB, pre-defined region, or CTU/CTB.

Any combination of the proposed methods in this invention can be applied.

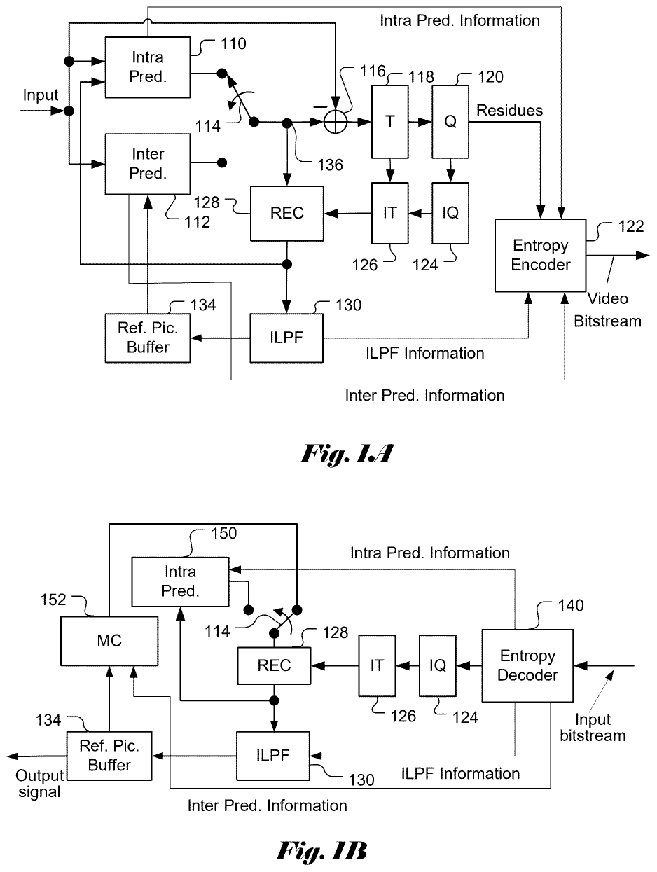

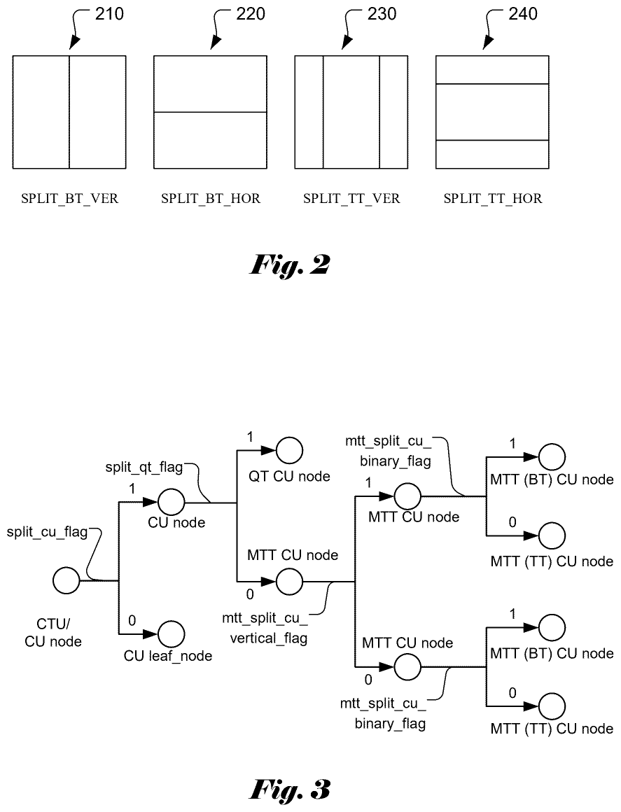

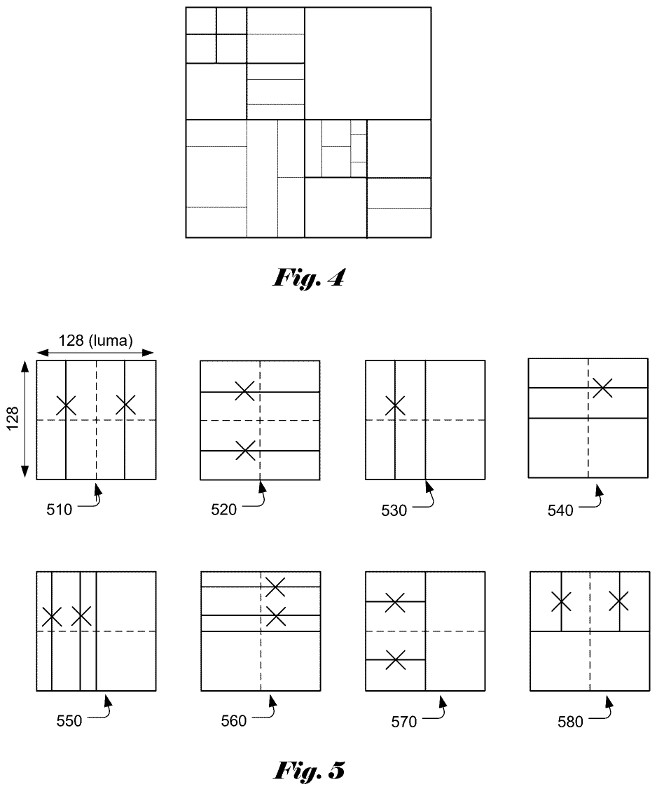

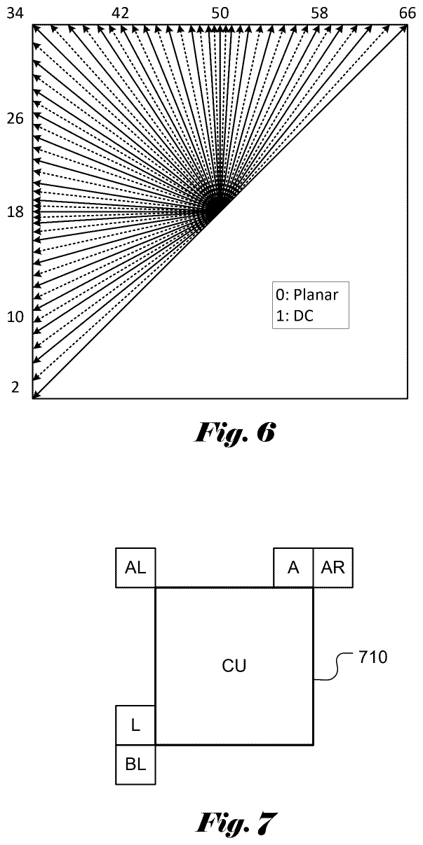

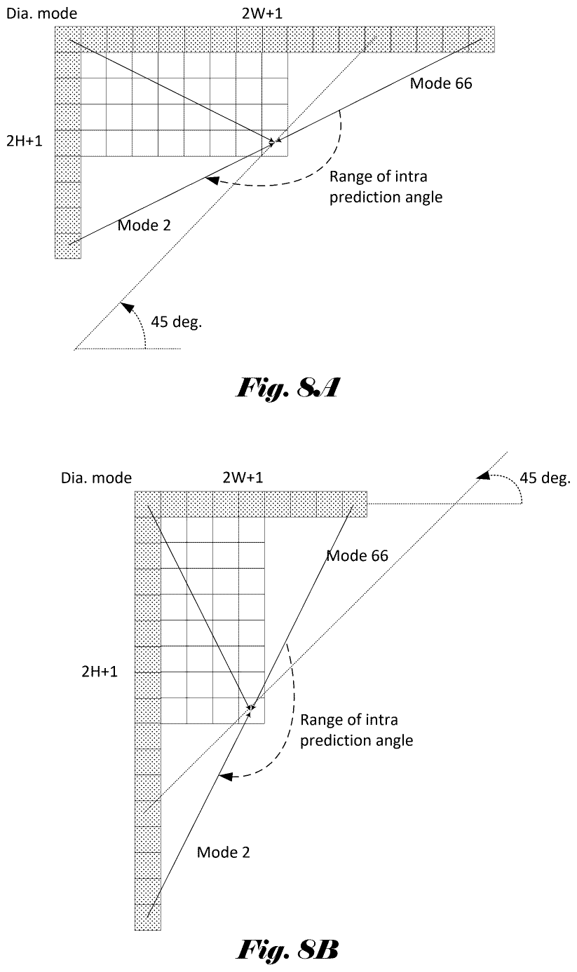

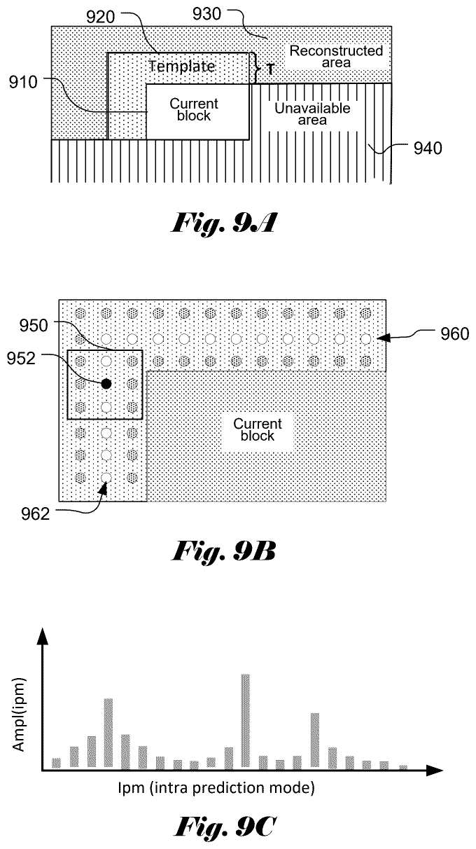

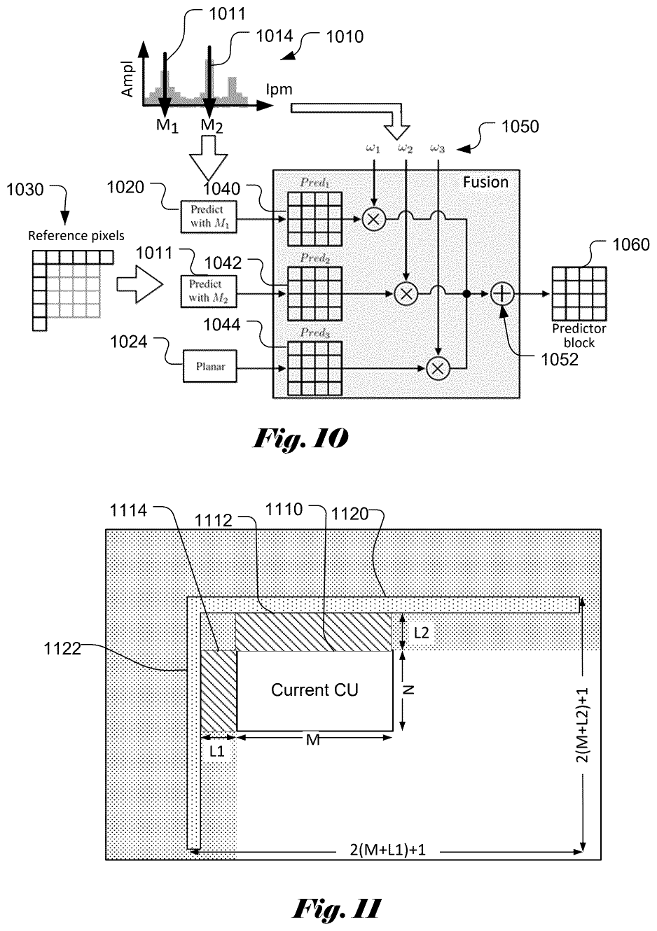

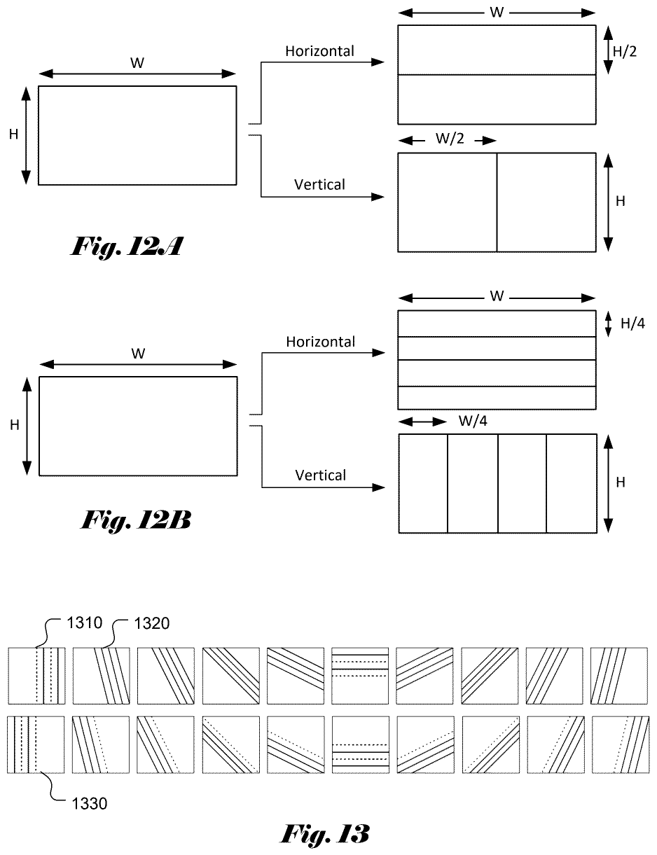

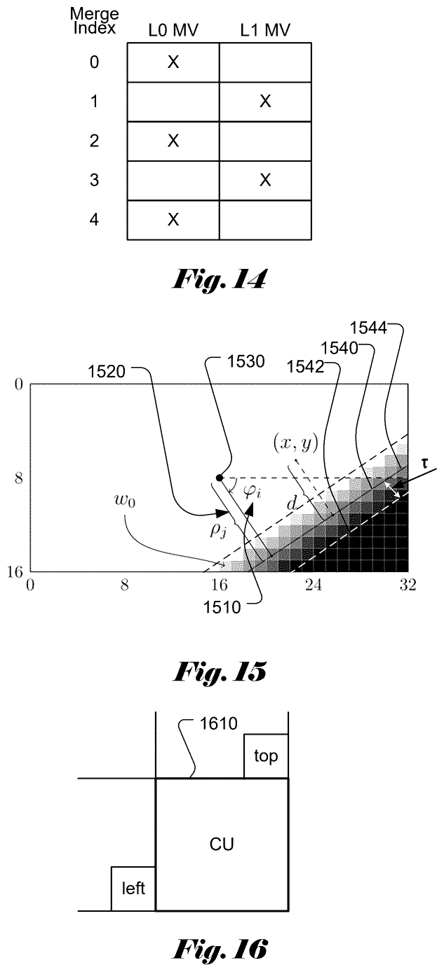

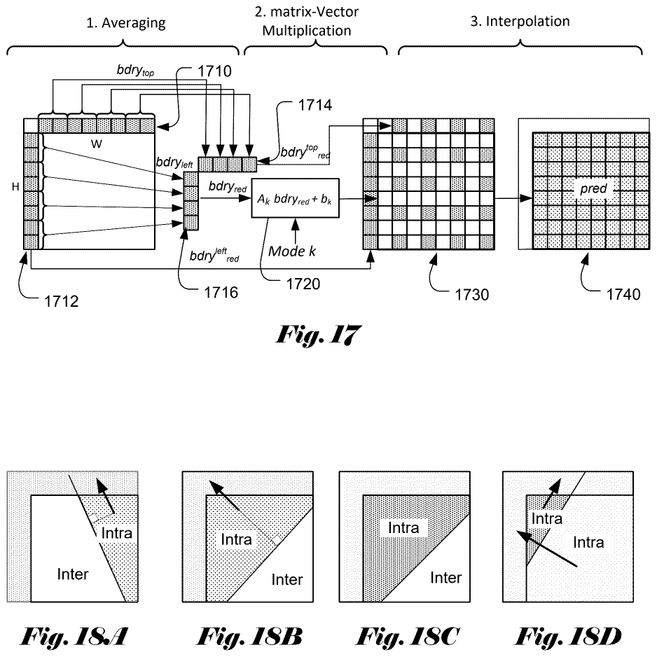

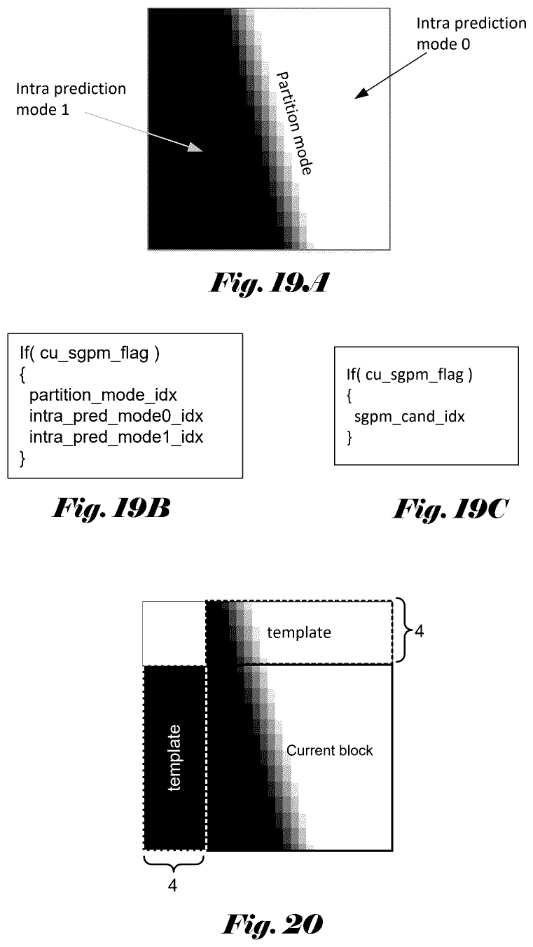

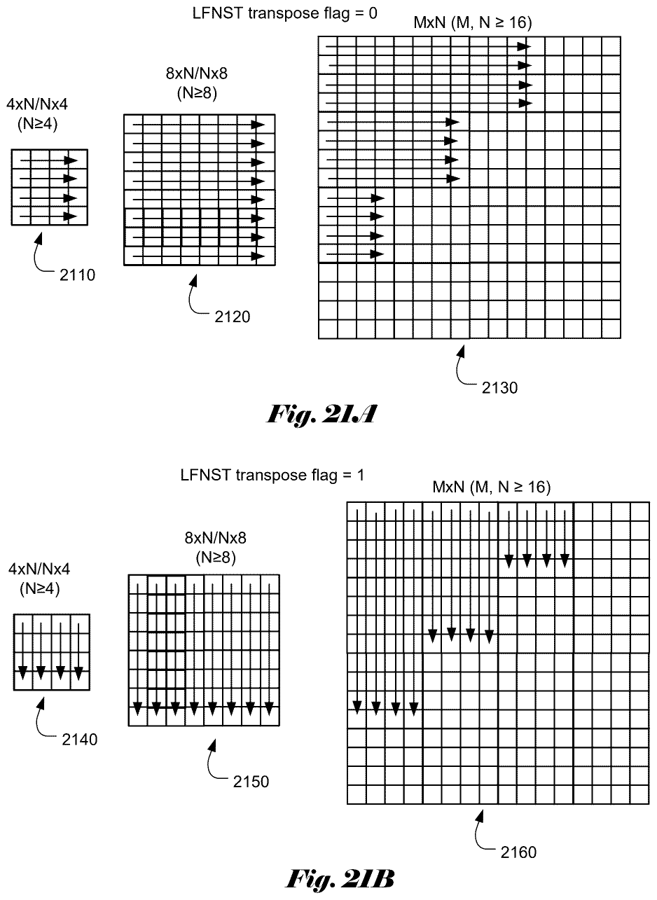

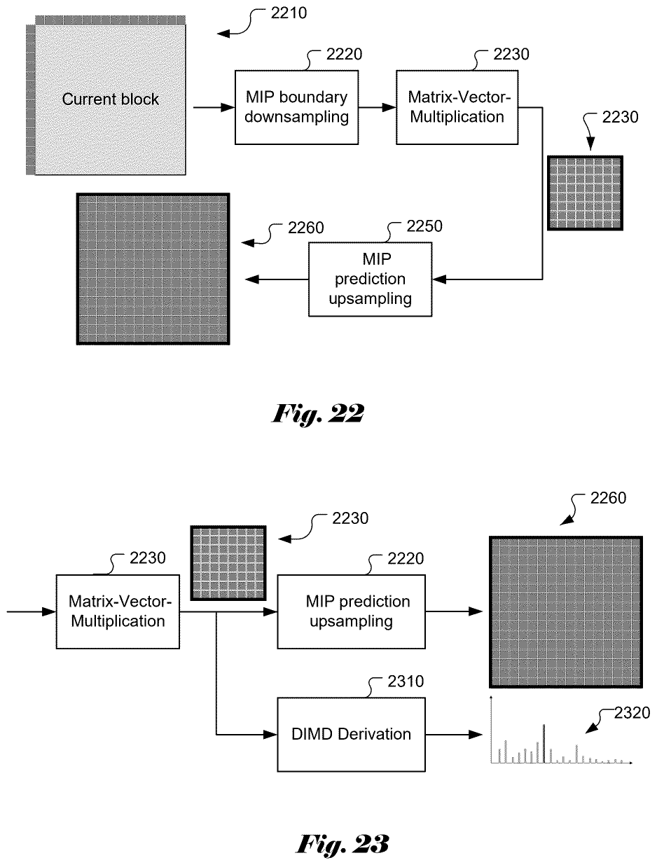

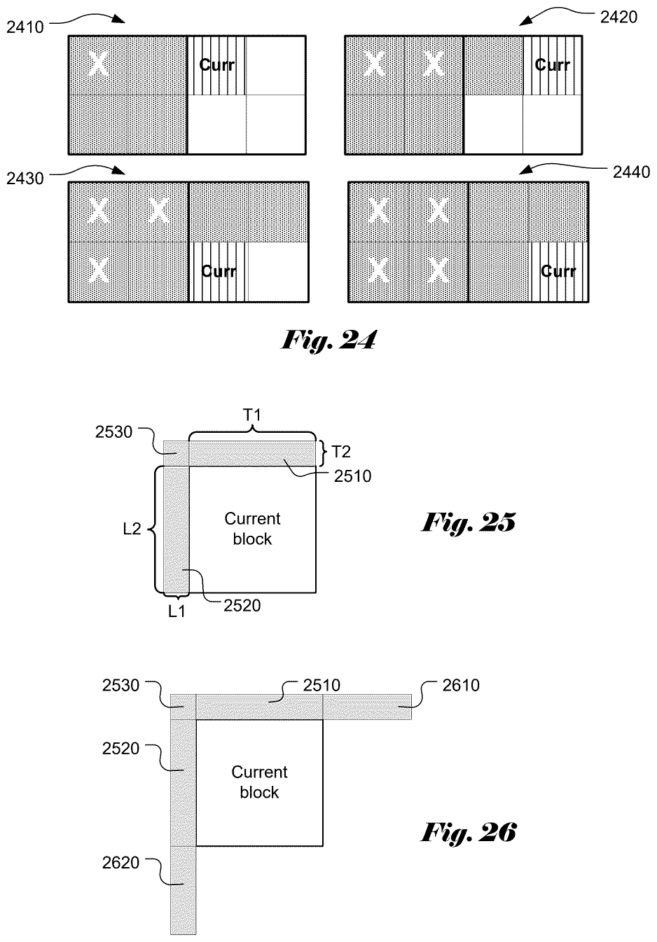

Any of the region-based intra prediction derivation methods can be implemented in encoders and/or decoders. For example, any of the proposed methods can be implemented in an inter/intra/prediction module (e.g. Intra Pred. 110 in FIG. 1A) of an encoder, and/or an inter/intra/prediction module (e.g. Intra Pred. 150 in FIG. 1B) of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

FIG. 40 illustrates a flowchart of an exemplary video coding system that incorporates region-based intra prediction mode derivation according to an embodiment of the present invention. The steps shown in the flowchart may be implemented as program codes executable on one or more processors (e.g., one or more CPUs) at the encoder side and/or decoder side. The steps shown in the flowchart may also be implemented based hardware such as one or more electronic devices or processors arranged to perform the steps in the flowchart. According to this method, input data associated with a current block are received in step 4010, wherein the input data comprise pixel data to be encoded at an encoder side or coded data associated with the current block to be decoded at a decoder side. A predefined target mode is determined for the current block in step 4020, wherein the predefined target mode uses template-based histogram, gradient analysis, template-based distortion calculation, or any-pre-defined prediction derivation based on template of the current block. A first flag is signalled or parsed for the current block to indicate whether to apply a region-based mode derivation process to the current block in step 4030. Whether the first flag for the current block indicates the region-based mode derivation process being applied is checked in step 4040. If the first flag for the current block indicates the region-based mode derivation process being applied (i.e., the Yes path from step 4040), steps 4042 to 4048 are performed. Otherwise ((i.e., the No path from step 4040)), step 4050 is performed. In step 4042, the template region is divided into at least two template regions. In step 4044, at least two intra prediction modes are derived from said at least two template regions using a predefined measurement for said at least two template regions respectively, wherein the predefined measurement comprises deriving at least one candidate list comprising at least one of said at least two intra prediction modes. In step 4046, at least two hypotheses of predictors are derived based on said at least two intra prediction modes. In step 4048, a final predictor is generated based on said at least two hypotheses of predictors. In step 4050, a final predictor is derived without using region-based prediction mode derivation process. The current block is encoded or decoded using the final predictor in step 4060.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data to be encoded at an encoder side or coded data associated with the current block to be decoded at a decoder side;
determining a predefined target mode for the current block, wherein the predefined target mode uses template-based histogram, gradient analysis, template-based distortion calculation, or any-pre-defined prediction derivation based on template of the current block;
signalling or parsing a first flag for the current block to indicate whether to apply a region-based mode derivation process to the current block;
in response to the first flag for the current block indicating the region-based mode derivation process being applied:
dividing the template into at least two template regions;
deriving at least two intra prediction modes from said at least two template regions using a predefined measurement for said at least two template regions respectively, wherein the predefined measurement comprises deriving at least one candidate list comprising at least one of said at least two intra prediction modes;
deriving at least two hypotheses of predictors based on said at least two intra prediction modes; and
generating a final predictor based on said at least two hypotheses of predictors; and
encoding or decoding the current block using the final predictor.

2. The method of claim 1, wherein the final predictor is derived by blending said at least two hypotheses of predictors.

3. The method of claim 2, wherein said at least two hypotheses of predictors are blended on a sample basis.

4. The method of claim 3, wherein said at least two hypotheses of predictors are blended using position-dependent weights.

5. The method of claim 3, wherein when said at least two template regions correspond to a top template region and a left template region, a top intra prediction mode and a left intra prediction mode are derived using the top template region and the left template region respectively, and wherein top weights for the top intra prediction mode have larger values for samples closer to the top template region, and/or left weights for the left intra prediction mode have larger values for samples closer to the left template region.

6. The method of claim 1, wherein said at least two template regions correspond to a top template region on top of the current block and a left template region on left of the current block.

7. The method of claim 6, wherein a top intra prediction mode and a left intra prediction mode are selected using the top template region and the left template region respectively, and wherein the top intra prediction mode and the left intra prediction mode correspond to a top intra prediction candidate and a left intra prediction candidate achieving smallest template-based distortions calculated using the top template region and the left template region respectively.

8. The method of claim 6, wherein the top template region is divided into multiple top sub-regions and/or the left template region is divided into multiple left sub-regions, and wherein the current block is divided into multiple grids horizontally, vertically or both according to the multiple top sub-regions and/or the multiple left sub-regions.

9. The method of claim 8, wherein multiple top subblock intra prediction modes are derived using the multiple top sub-regions respectively and/or multiple left subblock intra prediction modes are derived using the multiple left sub-regions respectively, and wherein a target subblock intra prediction mode is derived for each grid based on a corresponding top subblock intra prediction mode associated with one top sub-region above said each grid and a corresponding left subblock intra prediction mode associated with one left sub-region on left of said each grid.

10. The method of claim 9, wherein the target subblock intra prediction mode is derived by blending said one top subblock intra prediction mode and said one left subblock intra prediction mode using weights.

11. The method of claim 9, wherein when ISP (Intra Sub-Partition) is applied to the current block, CB (Coding Block) position is used to derive position-dependent weights for blending subblock intra prediction modes.

12. The method of claim 9, wherein boundary samples between two adjacent grids are derived by blending predictors generated using subblock intra prediction modes comprising two top subblock intra prediction modes derived for two horizontally adjacent grids, two adjacent left subblock intra prediction modes derived for two vertically adjacent grids, or both.

13. The method of claim 8, wherein the top template region is divided into the multiple top sub-regions and/or the left template region is divided into the multiple left sub-regions when block width, block height, or both of the current block are greater than a threshold.

14. The method of claim 6, wherein at least one of three best modes and/or at least one of three second-best modes are derived based on at least one of both the top template region and the left template region, the top template region only and the left template region only respectively, and wherein a candidate list for a pre-defined template region is determined based on a basic candidate list and adjusted by any subset of one best mode and/or one second-best mode with an offset.

15. The method of claim 14, wherein when best modes for a first sub-region and a second sub-region are the same, a best mode for one of the first sub-region and the second sub-region is changed to a second-best mode.

16. The method of claim 1, wherein a second flag is signalled or parsed, and wherein the second flag indicate whether the region-based mode derivation process is applied to the current block.

17. The method of claim 16, wherein the second flag is signalled or parsed only when both an above template region and a left template region are available.

18. The method of claim 16, wherein the second flag is signalled or parsed only if block width or height of the current block is larger than a threshold.

19. The method of claim 1, wherein an intra prediction mode for the current block is stored and/or referenced by one or more subsequent coding blocks or the intra prediction mode for the current block is stored for a pre-defined processing of the current block.

20. The method of claim 19, wherein the intra prediction mode stored is used for MPM generation and/or chroma DM (Direct Mode) for said one or more subsequent coding blocks.

21. The method of claim 19, wherein the intra prediction mode stored is used for transform process of the current block.

22. The method of claim 19, wherein the intra prediction mode is any one of available intra prediction modes comprising DC, planar, angular modes, 67 intra prediction modes, or 131 intra prediction modes.

23. The method of claim 19, wherein the intra prediction mode is derived by any of implicit derivation schemes comprising a template-based derivation, decoder-side derivation) or a combination thereof.

24. The method of claim 19, wherein the intra prediction mode corresponds to a best mode or a second-best mode derived by according to TIMD (Template-based Intra Mode Derivation) using both a top template region and a left template region, the top template region only, or the left template region only.

25. An apparatus of video coding, the apparatus comprising one or more electronics or processors arranged to:
receive input data associated with a current block, wherein the input data comprise pixel data to be encoded at an encoder side or coded data associated with the current block to be decoded at a decoder side;
determine a predefined target mode for the current block, wherein the predefined target mode uses template-based histogram, gradient analysis, template-based distortion calculation, or any-pre-defined prediction derivation based on template of the current block;
signal or parse a first flag for the current block to indicate whether to apply a region-based mode derivation process to the current block;
in response to the first flag for the current block indicating the region-based mode derivation process being applied:
divide the template into at least two template regions;
derive at least two intra prediction modes from said at least two template regions using a predefined measurement for said at least two template regions respectively, wherein the predefined measurement comprises deriving at least one candidate list comprising at least one of said at least two intra prediction modes;
derive at least two hypotheses of predictors based on said at least two intra prediction modes; and
generate a final predictor based on said at least two hypotheses of predictors; and
encode or decode the current block using the final predictor.
